(19) United States
(12) Patent Application Publication
(10) Pub. No.: US 2025/0173842 A1
(43) Pub. Date: May 29, 2025

(54) PROCESSING A SPECTRUM IMAGE MEASUREMENT

(71) Applicant: SENSORZ TECH LTD., Kfar Saba (IL)

(72) Inventors: Ziv Nuss, Tzur Yigal (IL); Elad Tzoref, Kokhav Yair (IL); Meir Friedland, Maas (IL)

(73) Assignee: SENSORZ TECH LTD., Kfar Saba (IL)

(21) Appl. No.: 19/039,875

(22) Filed: Jan. 29, 2025

Related U.S. Application Data
(63) Continuation-in-part of application No. PCT/IL2023/050791, filed on Jul. 31, 2023.
(60) Provisional application No. 63/393,931, filed on Jul. 31, 2022.

(51) Int. Cl. G06T 5/70; G06T 7/11

(52) U.S. Cl. CPC G06T 5/70; G06T 7/11; G06T 2207/10036; G06T 2207/20072; G06T 2207/20076; G06T 2207/20081; G06T 2207/20084; G06T 2207/20182

(57) ABSTRACT

Embodiments of the present disclosure may include a method for processing a spectrum image measurement, the method including receiving a spectrum image measurement. In some embodiments, the spectrum image measurement may include a plurality of power-frequency data values as a function of time and time data. Embodiments may also include selecting a prediction result based at least in part on the time data and an uncertainty model. Embodiments may also include generating a residual error image by applying the prediction result to the power-frequency data. Embodiments may also include scanning the residual error image for an anomaly. In some embodiments, an anomaly may be based at least in part on a portion of the residual error image exceeding a threshold range between a prediction result value and the power-frequency measured data value.

### CROSS REFERENCE TO RELATED APPLICATION

The present application is a Continuation-in-Part (CIP) of International Application No. PCT/IL2023/050791, filed Jul. 31, 2023, which claims priority to U.S. Provisional Patent Application No. 63/393,931, filed Jul. 31, 2022, the entire contents of each of these applications are incorporated herein by reference.

### TECHNICAL FIELD

The subject matter herein relates, generally, to methods and systems for detecting and classifying spectral signals within power spectral density (PSD) spectrograms, and, more particularly, to computer-implemented techniques for preprocessing, training, and applying neural networks to localize regions of interest (ROIs), classify spectral objects, and iteratively refine detection models using annotated data and domain-specific augmentations. The disclosure further pertains to the Sensor Wireless Observability, Reconnaissance, and Detection (SWORD) architecture, which leverages distributed sensors, neural network models, and scalable computational frameworks to perform signals detection, classification, anomaly recognition, and real-time response actions in dynamic RF environments.

### SUMMARY

Embodiments of the present disclosure include a method for processing a spectrum image measurement. The method includes receiving a spectrum image measurement, where the spectrum image measurement includes a plurality of power-frequency measured data values as a function of time and time data. In some embodiments, the method includes selecting a baseline prediction model based at least in part on the time data and an uncertainty model.

Embodiments also include generating a residual error image by applying the baseline prediction model to the power-frequency data. The residual error image represents deviations between the predicted values and the power-frequency measured data values. Embodiments further include scanning the residual error image for an anomaly, where an anomaly is identified based at least in part on a portion of the residual error image exceeding a threshold range between the prediction result value and the power-frequency measured data value.

Embodiments also include determining a portion of the anomalous power-frequency data set associated with the portion of the residual error image that exceeds the threshold range between the baseline prediction result value and the power-frequency measured data value. Embodiments may include generating bounding boxes for localized regions of interest (ROIs) within the anomalous power-frequency data set, allowing identification and segmentation of anomaly regions.

In some embodiments, the method includes performing at least one local denoising step on the residual error image. This step involves creating a plurality of partitions of the anomalous power-frequency data set into regions of low variance, averaging the power-frequency measured data values within each partition, and generating a locally denoised residual error image. The locally denoised residual error image highlights local anomaly regions and their corresponding local background images.

In other embodiments, the method includes performing at least one global denoising step on the locally denoised residual error image. This step includes generating a globally denoised residual error image with at least one global anomaly region and a global background region. The globally denoised residual error image may be refined using a globally optimal segmentation solution. For example, applying a graph-cut algorithm or probabilistic inference methods, such as iterated conditional mode (ICM), refines segmentation of global anomaly regions.

Embodiments further include applying a classification model to the bounding box image of at least one anomaly region. Such classifications may be based on features such as signal intensity, frequency, and modulation patterns, enabling identification of spectral objects within anomaly regions. In some embodiments, classifications may associate bounding box images with specific issue classes, including security threats, network anomalies, or quality-of-service concerns.

Embodiments also include applying domain-specific augmentations during the training process of the neural network. Such augmentations include random erasing, automatic gain control (AGC) simulation, and noise floor adjustments to enhance the neural network's ability to extract robust features from the spectrum image measurement. These techniques improve the ability to localize regions of interest, as evaluated by metrics such as Intersection over Union (IoU), mean average precision (mAP), and mean average recall (mAR).

In some embodiments, the method includes performing iterative training of the neural network. This training incorporates user annotations and a hierarchical classification framework. The hierarchical classification organizes signals into predefined categories or families, enabling granularity in signal classification. Unknown signals may be flagged as new signal types for further analysis.

Embodiments may also include clustering unknown signals and selecting representative signals for user annotations. A recommendation engine provides structured annotation flows, including:
Initial clustering to group signals with shared characteristics,
Prioritization of signals with low-confidence classifications for active learning,
Identification of unknown signals for novel classification, and
Grouping of signals similar to previously annotated examples to reduce redundancy.

Embodiments further include assessing the health of scanning network sensors by comparing scanned cliques with historical scanned cliques. This process includes extracting a scanned clique from the spectrum image measurement, retrieving historical subgraphs of scanned cliques, and applying a sensor health monitoring service to determine consistency. Health statuses, such as faulty, conditional, or healthy, are associated with each network sensor based on these comparisons.

Embodiments also include refining bounding box generation by detecting contours of spectral objects and distinguishing overlapping regions. This process assigns portions of overlapping regions to bounding boxes based on differences in signal intensity, frequency, or time duration. Additionally, globally denoised residual error images may be used to extract bounding boxes and refine segmentation boundaries.

In some embodiments, the method includes decoding information from received spectrum image measurements. This includes applying decoders tailored to wireless communication protocols, such as 5G, LTE, or IoT networks, to validate denoising steps or refine classifications. Decoded information may further assist in associating anomalies with specific threats, such as jammers, rogue cells, or uplink/downlink transmission issues.

Embodiments may also include dynamically allocating computational tasks between a central unit and edge servers. For instance, model training may occur centrally, while inference and anomaly detection tasks may be performed on edge servers. Such dynamic allocation ensures effective use of computational resources.

Embodiments further include transmitting anomaly notifications, based on detected anomalies, to user interfaces or external systems. Notifications may include visual or audible alerts that classify the anomaly and its underlying cause. These notifications provide actionable insights for operators managing wireless networks or RF environments.

In some embodiments, the system may include a coupling service that integrates data from multiple sources, such as cell managers, RF inference services, and sensor network graphs. The coupling service associates anomalous behaviors across these data sources, enabling comprehensive anomaly detection and resolution.

### BRIEF DESCRIPTION OF THE FIGURES

FIG. 1 is a flowchart illustrating a method for processing a spectrum image measurement, according to some embodiments of the present disclosure.

FIG. 2 is a flowchart further illustrating the method for processing a spectrum image measurement from FIG. 1, according to some embodiments of the present disclosure.

FIG. 3 is a flowchart further illustrating the method for processing a spectrum image measurement from FIG. 1, according to some embodiments of the present disclosure.

FIG. 4 is a flowchart further illustrating the method for processing a spectrum image measurement from FIG. 1, according to some embodiments of the present disclosure.

FIG. 5 is a flowchart further illustrating the method for processing a spectrum image measurement from FIG. 1, according to some embodiments of the present disclosure.

FIG. 6 is a flowchart further illustrating the method for processing a spectrum image measurement from FIG. 1, according to some embodiments of the present disclosure.

FIG. 7A is a flowchart further illustrating the method for processing a spectrum image measurement from FIG. 1, according to some embodiments of the present disclosure.

FIG. 7B is a flowchart extending from FIG. 7A and further illustrating the method for processing a spectrum image measurement from FIG. 1, according to some embodiments of the present disclosure.

FIG. 8A is a flowchart further illustrating the method for processing a spectrum image measurement from FIG. 1, according to some embodiments of the present disclosure.

FIG. 8B is a flowchart extending from FIG. 8A and further illustrating the method for processing a spectrum image measurement from FIG. 1, according to some embodiments of the present disclosure.

FIG. 9 is a flowchart further illustrating the method for processing a spectrum image measurement from FIG. 1, according to some embodiments of the present disclosure.

FIG. 10A is a flowchart further illustrating the method for processing a spectrum image measurement from FIG. 1, according to some embodiments of the present disclosure.

FIG. 10B is a flowchart extending from FIG. 10A and further illustrating the method for processing a spectrum image measurement from FIG. 1, according to some embodiments of the present disclosure.

FIG. 11A is a flowchart further illustrating the method for processing a spectrum image measurement from FIG. 1, according to some embodiments of the present disclosure.

FIG. 11B is a flowchart extending from FIG. 11A and further illustrating the method for processing a spectrum image measurement from FIG. 1, according to some embodiments of the present disclosure.

FIG. 12A is a flowchart further illustrating the method for processing a spectrum image measurement from FIG. 1, according to some embodiments of the present disclosure.

FIG. 12B is a flowchart extending from FIG. 12A and further illustrating the method for processing a spectrum image measurement from FIG. 1, according to some embodiments of the present disclosure.

FIG. 13A is a flowchart further illustrating the method for processing a spectrum image measurement from FIG. 1, according to some embodiments of the present disclosure.

FIG. 13B is a flowchart extending from FIG. 13A and further illustrating the method for processing a spectrum image measurement from FIG. 1, according to some embodiments of the present disclosure.

FIG. 14A is a flowchart further illustrating the method for processing a spectrum image measurement from FIG. 1, according to some embodiments of the present disclosure.

FIG. 14B is a flowchart extending from FIG. 14A and further illustrating the method for processing a spectrum image measurement from FIG. 1, according to some embodiments of the present disclosure.

FIG. 15A is a flowchart further illustrating the method for processing a spectrum image measurement from FIG. 1, according to some embodiments of the present disclosure.

FIG. 15B is a flowchart extending from FIG. 15A and further illustrating the method for processing a spectrum image measurement from FIG. 1, according to some embodiments of the present disclosure.

FIG. 16A is a flowchart further illustrating the method for processing a spectrum image measurement from FIG. 1, according to some embodiments of the present disclosure.

FIG. 16B is a flowchart extending from FIG. 16A and further illustrating the method for processing a spectrum image measurement from FIG. 1, according to some embodiments of the present disclosure.

FIG. 17A is a flowchart further illustrating the method for processing a spectrum image measurement from FIG. 1, according to some embodiments of the present disclosure.

FIG. 17B is a flowchart extending from FIG. 17A and further illustrating the method for processing a spectrum image measurement from FIG. 1, according to some embodiments of the present disclosure.

FIG. 18A is a flowchart further illustrating the method for processing a spectrum image measurement from FIG. 1, according to some embodiments of the present disclosure.

FIG. 18B is a flowchart extending from FIG. 18A and further illustrating the method for processing a spectrum image measurement from FIG. 1, according to some embodiments of the present disclosure.

FIG. 19 is a flowchart further illustrating the method for processing a spectrum image measurement from FIG. 1, according to some embodiments of the present disclosure.

FIG. 20 is a flowchart further illustrating the method for processing a spectrum image measurement from FIG. 1, according to some embodiments of the present disclosure.

FIG. 21 is a flowchart further illustrating the method for processing a spectrum image measurement from FIG. 1, according to some embodiments of the present disclosure.

FIG. 22 is a flowchart illustrating a method for processing a spectrum image measurement, according to some embodiments of the present disclosure.

FIG. 23 is a flowchart further illustrating the method for processing a spectrum image measurement from FIG. 22, according to some embodiments of the present disclosure.

FIG. 24 is a flowchart further illustrating the method for processing a spectrum image measurement from FIG. 22, according to some embodiments of the present disclosure.

FIG. 25 is a circuit diagram of a distributed circuit architecture, according to some embodiments of the present disclosure.

FIG. 26 is an example table showing some tradeoffs, according to some embodiments of the present disclosure.

FIG. 27 depicts an exemplary network system for determining anomalous behavior.

FIG. 28 depicts an exemplary RF inference service flow.

FIG. 29 depicts a multi-phase training process 2900 for a neural network, incorporating self-supervised learning, iterative object detection training, and user annotations to create and refine an objectness model for detecting and classifying spectral objects within PSD spectrogram data.

FIG. 30 depicts Training Phase Three (3), in which the neural network is iteratively fine-tuned using annotated signals and spectral images to classify signals, identify unknown signal types, and prepare the model to be applied in the inference process.

FIG. 31 depicts a high-level depiction of the core training processes involved in the spectral object detection pipeline, emphasizing the iterative refinement and adaptability of the neural network through user-provided feedback and robust training paradigms.

FIG. 32 provides a comprehensive overview of the components and workflows within the system, from data acquisition to user interaction, enabling robust detection and classification of spectral objects.

### DETAILED DESCRIPTION

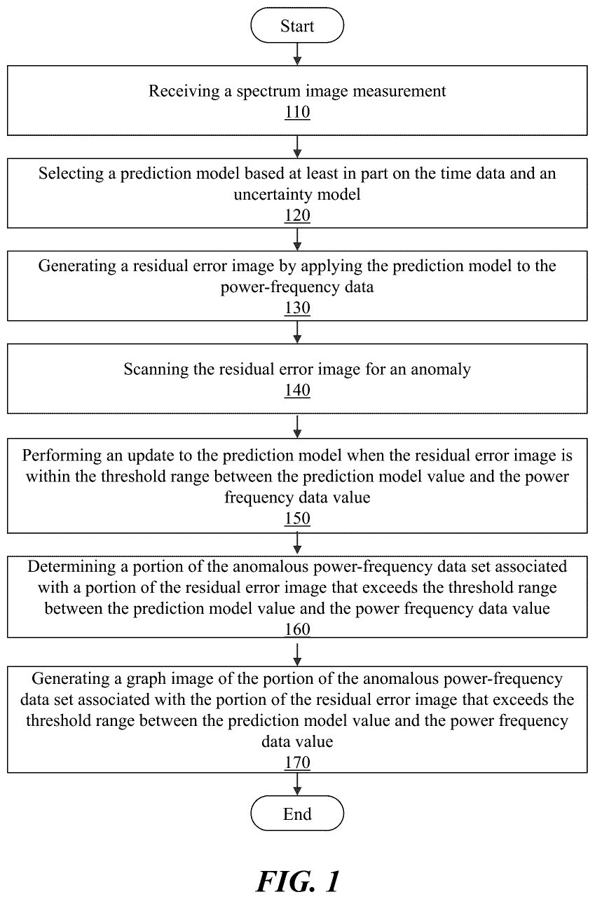

FIG. 1 is a flowchart that describes a method for processing a spectrum image measurement, according to some embodiments of the present disclosure. In some embodiments, at 110, the method may include receiving a spectrum image measurement. At 120, the method may include selecting a prediction based at least in part on the time data and an uncertainty model. At 130, the method may include generating a residual error image by applying the prediction to power-frequency data. At 140, the method may include scanning the residual error image for an anomaly.

In some embodiments, at 150, the method may include performing an update to a baseline prediction to an updated prediction when the residual error image may be within the threshold range between a prediction value and a power-frequency data value, which may be a measured value (e.g., a power-frequency measured data value). At 160, the method may include determining a portion of an anomalous power-frequency data set associated with a portion of the residual error image that exceeds a threshold range between the prediction value and the power-frequency data value. At 170, the method may include generating a residual error image of the portion of the anomalous power-frequency data set associated with the portion of the residual error image that exceeds a threshold range between the prediction value and the power-frequency data value. The spectrum image measurement may comprise a plurality of power-frequency data values as a function of time and time data. An anomaly may be based at least in part on a portion of the residual error image exceeding the threshold range between the prediction value and the power-frequency data value.

In some embodiments, the method may include applying a classifier to the residual error image, where the classifier may be configured to recognize types of signals according to how communication signals are characterized according to, e.g., frequency, power, and time patterns. In some embodiments, the method may include transmitting a request to at least one RF sensor for the spectrum image measurement. In some embodiments, the spectrum image measurement may comprise a range of frequencies. In some embodiments, the range of frequencies may be at least a selection of frequencies within an extremely low frequency (ELF) band of less than 4 KHz, a very low frequency (VLF) band between 3 KHz to 30 KHz, a low frequency (LF) band between 30 KHz to 300 KHz, a medium frequency (MF) band between 300 KHz to 3 MHZ, a high frequency (HF) band between 3 MHz to 30 MHZ, a very high frequency (VHF) band between 30 MHz to 300 MHZ, an ultra-high frequency (UHF) band between 300 MHz to 3 GHZ, a super high frequency (SHF) band between 3 GHz to 30 GHZ, and an extremely high frequency (SHF) band between 30 GHz to 300 GHZ.

Still referring to FIG. 1, in some embodiments, selecting a prediction based at least in part on the time data and/or an uncertainty model further comprises matching an attribute of the time data to the prediction. The time data may be at least one of seasonality characteristics, an event characteristic, and/or an external resources characteristic. In some embodiments, an attribute of a scanning network sensor may be at least one of a sensor location, a sensor identification, a sensor health parameter, a sensor orientation, a sensor configuration parameter, a similarity graph, a historical clique graph, and/or a historical power spectrum data. In some embodiments, an attribute of a scanning network sensor may be a sensor frequency scanning capability of at least one of a WiFi network, a cellular network, and/or a radio network.

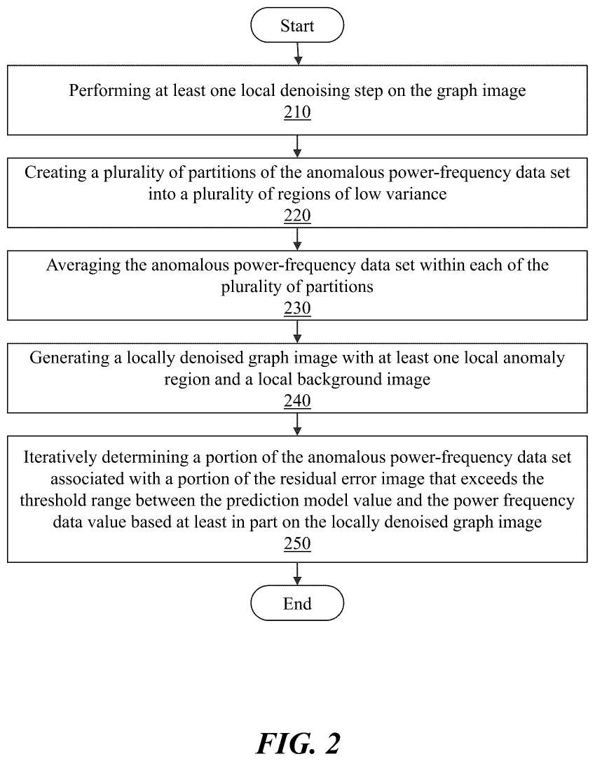

FIG. 2 is a flowchart that further describes the method for processing a spectrum image measurement from FIG. 1, according to some embodiments of the present disclosure. In some embodiments, at 210, the method may include performing at least one local denoising step on the residual error image. In some embodiments, the performing at least one local denoising step on the residual error image may further include 220, 230, and 240, which respectively include creating a plurality of partitions of the anomalous power-frequency data set into a plurality of regions of low variance, averaging the anomalous power-frequency data set within each of the plurality of partitions, and generating a locally denoised graph image with at least one local anomaly region and a local background image. In some embodiments, at 250, the method may include iteratively determining a portion of the anomalous power-frequency data set associated with a portion of the residual error image that exceeds the threshold range between the prediction value and the power-frequency measured data value based at least in part on the locally denoised residual error image.

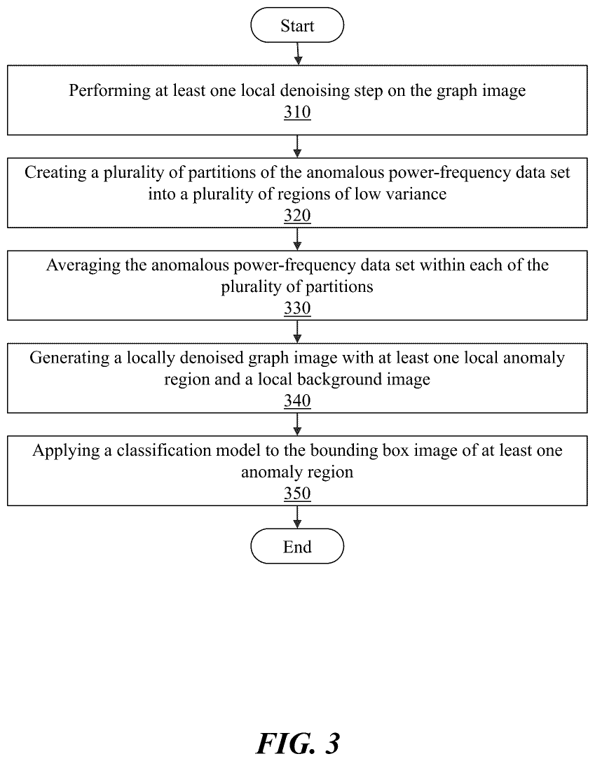

FIG. 3 is a flowchart that further describes the method for processing a spectrum image measurement from FIG. 1, according to some embodiments of the present disclosure. In some embodiments, at 310, the method may include performing at least one local denoising step on the residual error image (e.g., a graph image). In some embodiments, the performing at least one local denoising step on the residual error image further comprises, at 320, creating a plurality of partitions of the anomalous power-frequency data set into a plurality of regions of low variance, at 330 averaging the anomalous power-frequency data set within each of the plurality of partitions, and at 340 generating a locally denoised graph image with at least one local anomaly region and a local background image. In some embodiments, at 350, the method may include applying a classification model to the bounding box image of at least one anomaly region. In some embodiments, applying a classification model to the bounding box image of at least one anomaly region further comprises associating the bounding box image of at least one anomaly region with at least one threat. Non-limiting examples of a threat include a Wideband Jammer, an IMSI catcher, a SMS Blaster, a new cell, a Rogue Cell, a Coverage Hole, an Unsynchronized TDD cell, a cellular uplink anomaly, and/or a cellular downlink transmission anomaly in a wireless transmission (for example transmissions anomalies in FDD and/or TDD modes).

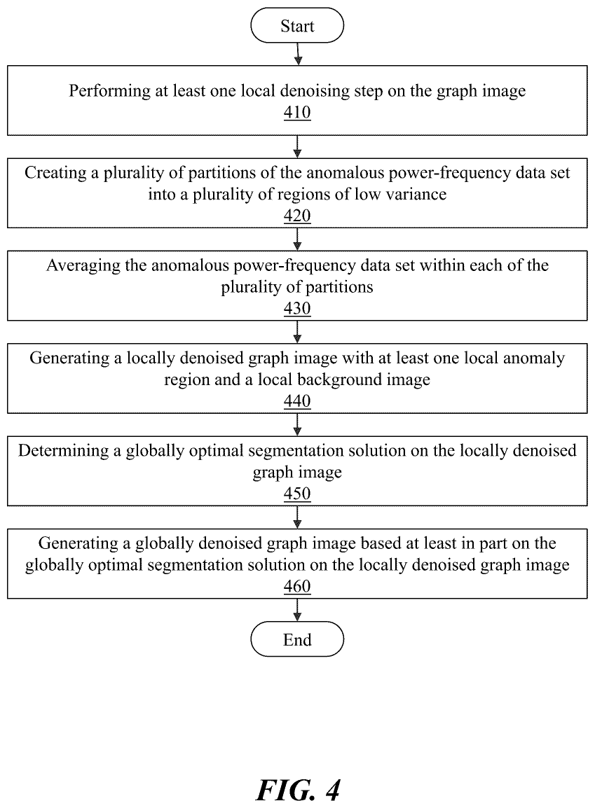

FIG. 4 is a flowchart that further describes the method for processing a spectrum image measurement from FIG. 1, according to some embodiments of the present disclosure. In some embodiments, at 410, the method may include performing at least one local denoising step on the residual error image (e.g., graph image). In some embodiments, the performing at least one local denoising step on the residual error image further comprises, creating a plurality of partitions of the anomalous power-frequency data set into a plurality of regions of low variance at 420, averaging the anomalous power-frequency data set within each of the plurality of partitions at 430, and generating a locally denoised graph image with at least one local anomaly region and a local background image at 440. In some embodiments, performing at least one global denoising step on the locally denoised residual error image further comprises generating a globally denoised residual error image with at least one global anomaly region and a global background region. In some embodiments, performing at least one global denoising step on the locally denoised residual error image further comprises determining a globally optimal segmentation solution on the locally denoised graph image at 450, and generating a globally denoised graph image based at least in part on the globally optimal segmentation solution on the locally denoised graph image at 460. In some embodiments, the determining a globally optimal segmentation solution further comprises applying a graph-cut algorithm to the locally denoised residual error image.

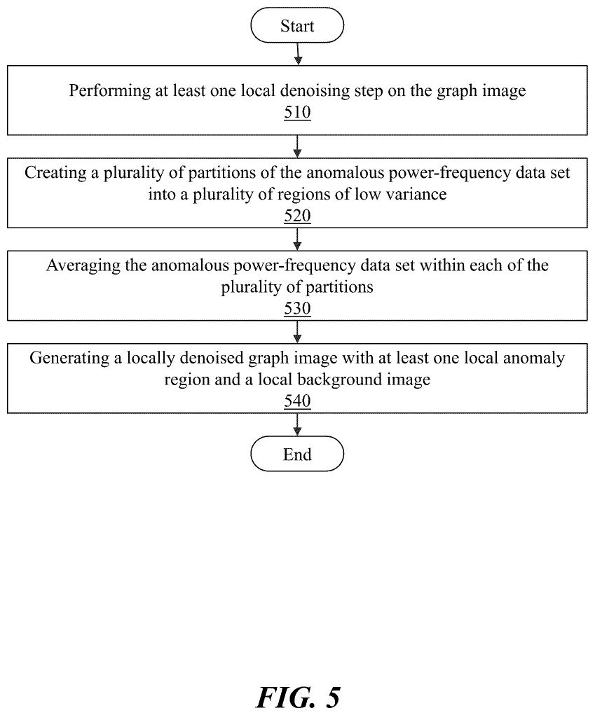

FIG. 5 is a flowchart that further describes the method for processing a spectrum image measurement from FIG. 1, according to some embodiments of the present disclosure. In some embodiments, at 210, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 520, averaging the anomalous power-frequency data set within each of the plurality of partitions at 530, and generating a locally denoised graph image with at least one local anomaly region and a local background image at 540. In some embodiments, performing at least one global denoising step on the locally denoised residual error image further comprises generating a globally denoised residual error image with at least one global anomaly region and a global background region.

Still referring to FIG. 5, in some embodiments, generating a globally denoised residual error image with at least once global anomaly region and a global background region further comprises implementing a probabilistic inference to the locally denoised residual error image. In some embodiments, implementing a probabilistic inference to the locally denoised residual error image further comprises applying an iterated conditional mode (ICM). An ICM may be applied using procedures for statistical inference in which a prior distribution is estimated from the at least one global anomaly region and a global background region data. In some embodiments, conditional mode (ICM) a probabilistic inference may be applied by implementing an empirical Bayes variable selection by iteratively minimizing a conditional loss function.

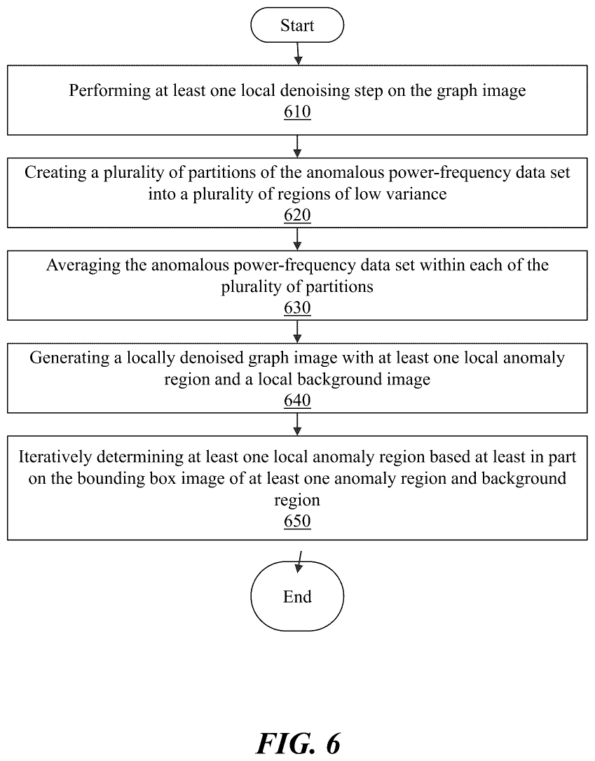

FIG. 6 is a flowchart that further describes the method for processing a spectrum image measurement from FIG. 1, according to some embodiments of the present disclosure. In some embodiments, at 610, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 620, averaging the anomalous power-frequency data set within each of the plurality of partitions at 630, and generating a locally denoised graph image with at least one local anomaly region and a local background image at 640. In some embodiments, performing at least one global denoising step on the locally denoised residual error image further comprises generating a globally denoised residual error image with at least one global anomaly region and a global background region.

Still referring to FIG. 6, in some embodiments, generating the globally denoised residual error image based at least in part on the globally optimal segmentation solution on the locally denoised residual error image further comprises extracting at least one bounding box of the at least one global anomaly region. In some embodiments, at 650, the method may include iteratively determining at least one local anomaly region based at least in part on the bounding box image of at least one anomaly region and background region.

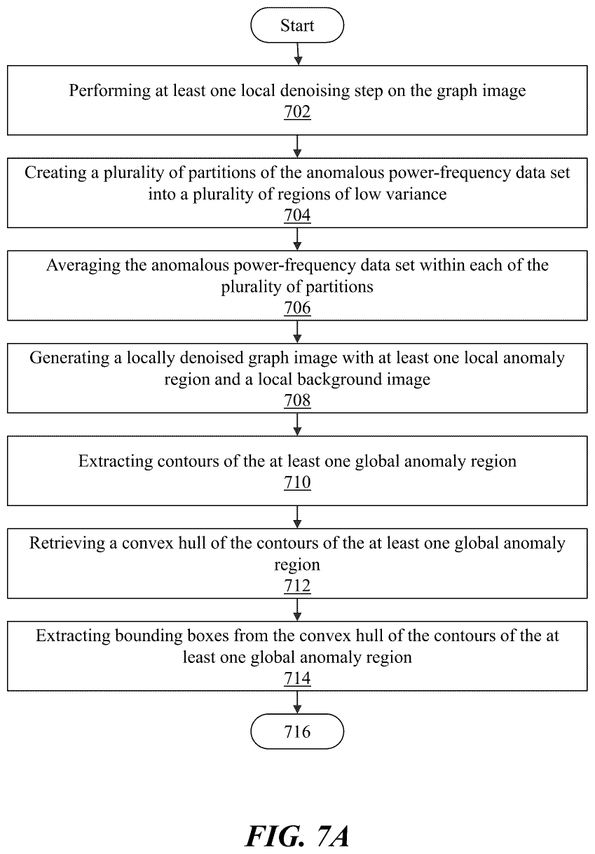

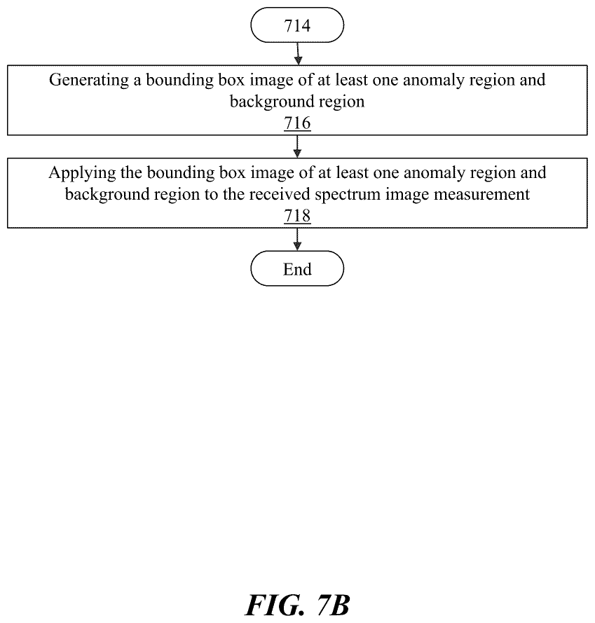

FIGS. 7A to 7B are a flowchart that further describes the method for processing a spectrum image measurement from FIG. 1, according to some embodiments of the present disclosure. In some embodiments, at 702, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 704, averaging the anomalous power-frequency data set within each of the plurality of partitions at 706, and generating a locally denoised graph image with at least one local anomaly region and a local background image at 708. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 710, the method may include extracting contours of the at least one global anomaly region. At 712, the method may include retrieving a convex hull of the contours of the at least one global anomaly region. At 714, the method may include extracting bounding boxes from the convex hull of the contours of the at least one global anomaly region. At 716, the method may include generating a bounding box image of at least one anomaly region and background region. In some embodiments, at 718, the method may include applying the bounding box image of at least one anomaly region and background region to the received spectrum image measurement.

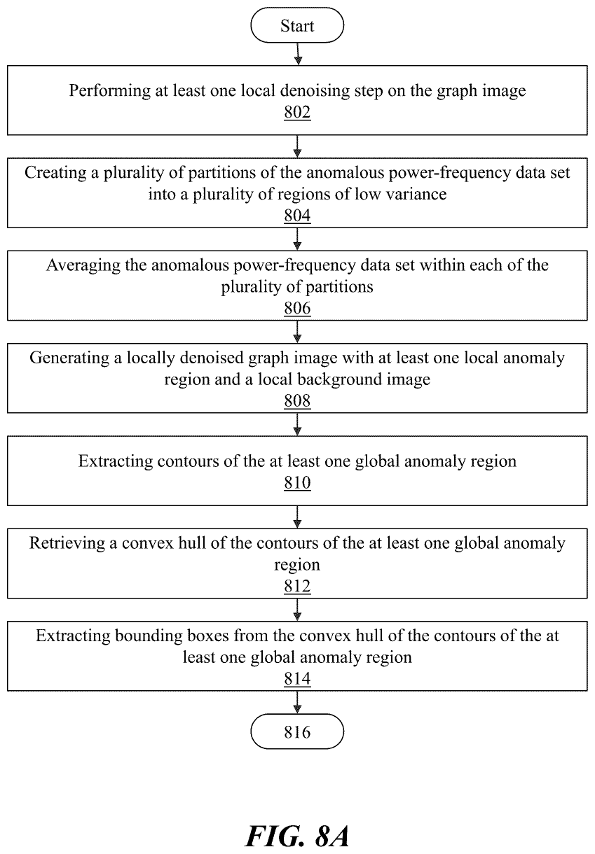

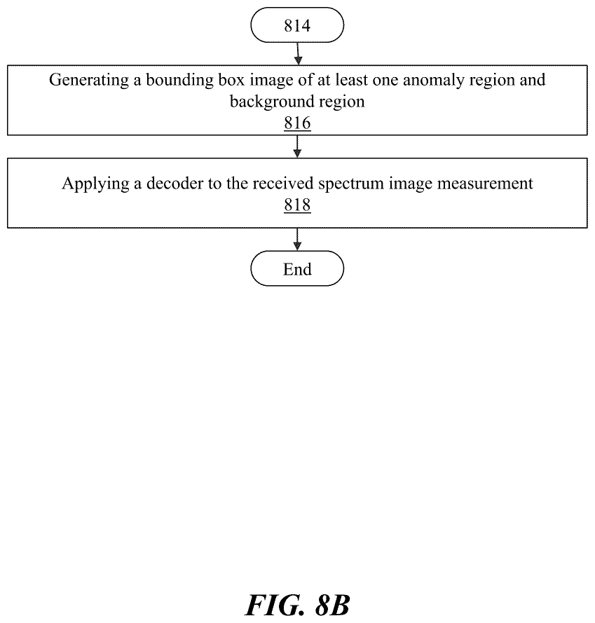

FIGS. 8A to 8B are a flowchart that further describes the method for processing a

spectrum image measurement from FIG. 1, according to some embodiments of the present disclosure. In some embodiments, at 802, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 804, averaging the anomalous power-frequency data set within each of the plurality of partitions at 806, and generating a locally denoised graph image with at least one local anomaly region and a local background image at 808. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 810, the method may include extracting contours of the at least one global anomaly region. At 812, the method may include retrieving a convex hull of the contours of the at least one global anomaly region. At 814, the method may include extracting bounding boxes from the convex hull of the contours of the at least one global anomaly region. At 816, the method may include generating a bounding box image of at least one anomaly region and background region. In some embodiments, at 818, the method may include applying a decoder to the received spectrum image measurement.

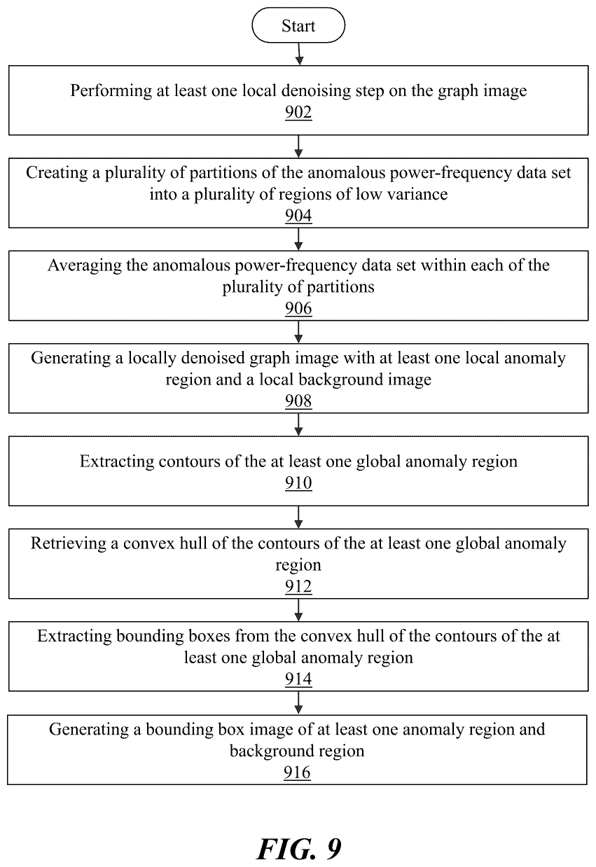

FIG. 9 is a flowchart that further describes the method for processing a spectrum image measurement from FIG. 1, according to some embodiments of the present disclosure. In some embodiments, at 902, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 904, averaging the anomalous power-frequency data set within each of the plurality of partitions at 906, and generating a locally denoised graph image with at least one local anomaly region and a local background image at 908. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 910, the method may include extracting contours of the at least one global anomaly region. At 912, the method may include retrieving a convex hull of the contours of the at least one global anomaly region. At 914, the method may include extracting bounding boxes from the convex hull of the contours of the at least one global anomaly region. At 916, the method may include generating a bounding box image of at least one anomaly region and background region. Some embodiments may include applying a decoder to the received spectrum image measurement, wherein the decoder may be a cellular frequency decoder. In some embodiments, the cellular frequency decoder may be at least one of a 2G decoder, a 3G decoder, a 4G and/or LTE decoder, a 5G decoder, and/or a 6G decoder.

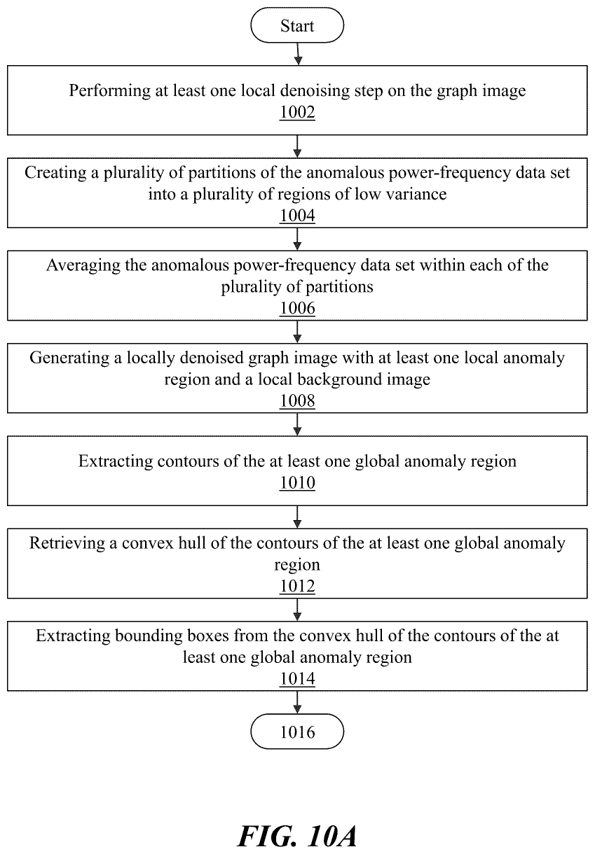

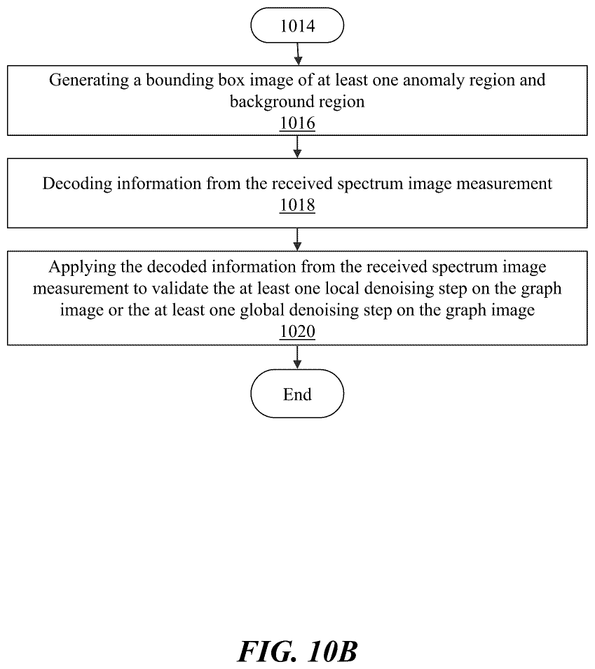

FIGS. 10A to 10B are a flowchart that further describes the method for processing a spectrum image measurement from FIG. 1, according to some embodiments of the present disclosure. In some embodiments, at 1002, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1004, averaging the anomalous power-frequency data set within each of the plurality of partitions at 1006, and generating a locally denoised graph image with at least one local anomaly region and a local background image at 1008. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1010, the method may include extracting contours of the at least one global anomaly region. At 1012, the method may include retrieving a convex hull of the contours of the at least one global anomaly region. At 1014, the method may include extracting bounding boxes from the convex hull of the contours of the at least one global anomaly region. At 1016, the method may include generating a bounding box image of at least one anomaly region and background region. In some embodiments, at 1018, the method may include decoding information from the received spectrum image measurement. In some embodiments, at 1020, the method may include applying the decoded information from the received spectrum image measurement to validate the at least one local denoising step on the residual error image (e.g., graph image) or the at least one global denoising step on the residual error image.

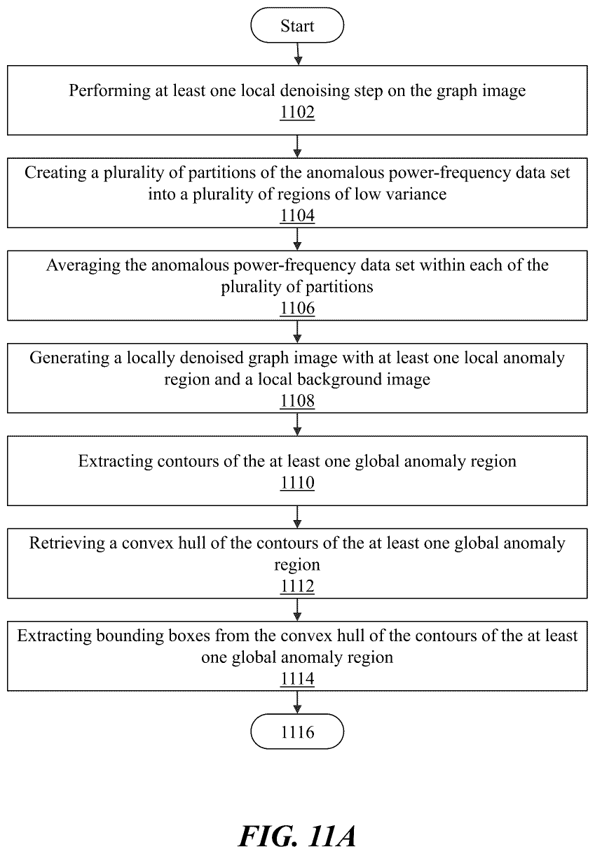

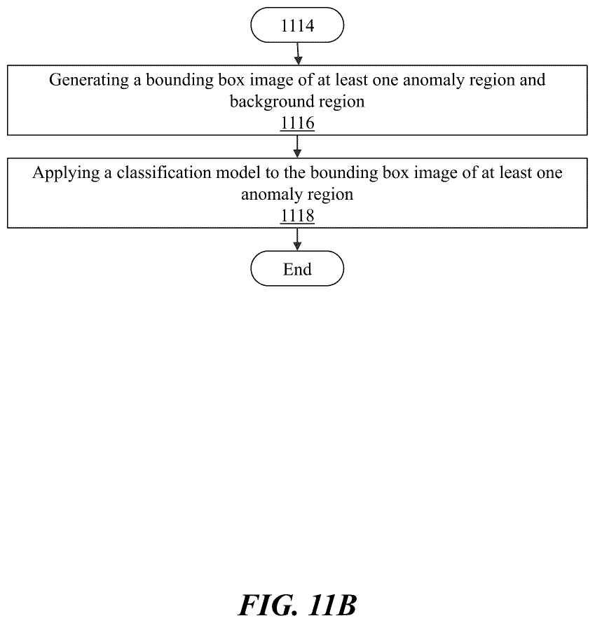

FIGS. 11A to 11B are a flowchart that further describes the method for processing a

spectrum image measurement from FIG. 1, according to some embodiments of the present disclosure. In some embodiments, at 1102, the method may include performing at least one local denoising step on the residual error image (e.g., graph image). In some embodiments, the performing at least one local denoising step on the graph image further comprises creating a plurality of partitions of the anomalous power-frequency data set into a plurality of regions of low variance at 1104, averaging the anomalous power-frequency data set within each of the plurality of partitions at 1106, and generating a locally denoised graph image with at least one local anomaly region and a local background image at 1108. In some embodiments, performing at least one global denoising step on the locally denoised graph image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1110, the method may include extracting contours of the at least one global anomaly region. At 1112, the method may include retrieving a convex hull of the contours of the at least one global anomaly region. At 1114, the method may include extracting bounding boxes from the convex hull of the contours of the at least one global anomaly region. At 1116, the method may include generating a bounding box image of at least one anomaly region and background region.

In some embodiments, at 1118, the method may include applying a classification model to the bounding box image of at least one anomaly region. In some embodiments, applying a classification model to the bounding box image of at least one anomaly region further comprises associating the bounding box image of at least one anomaly region with at least one of a Wideband Jammer, an IMSI catcher, a SMS Blaster, a new cell, a Rogue Cell, a Coverage Hole, an Unsynchronized TDD cell, and/or an Uplink anomaly.

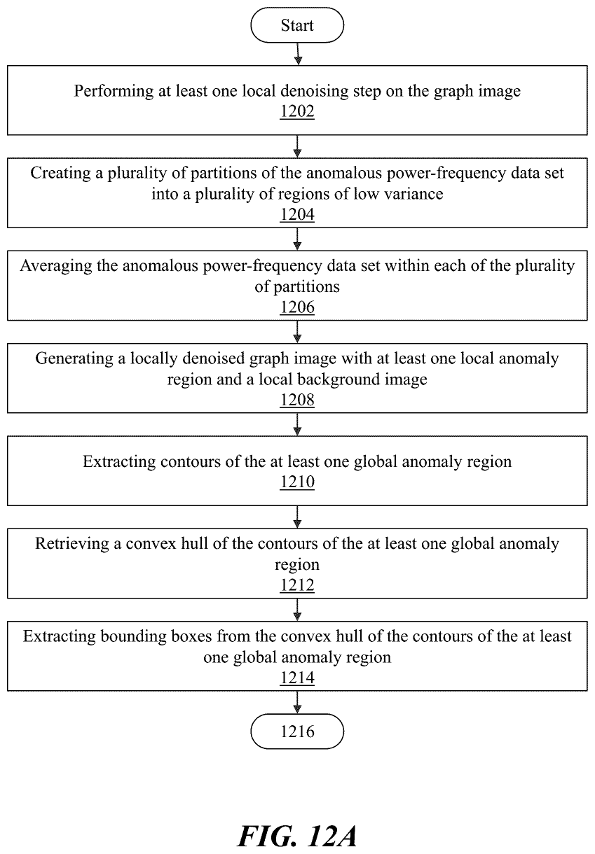

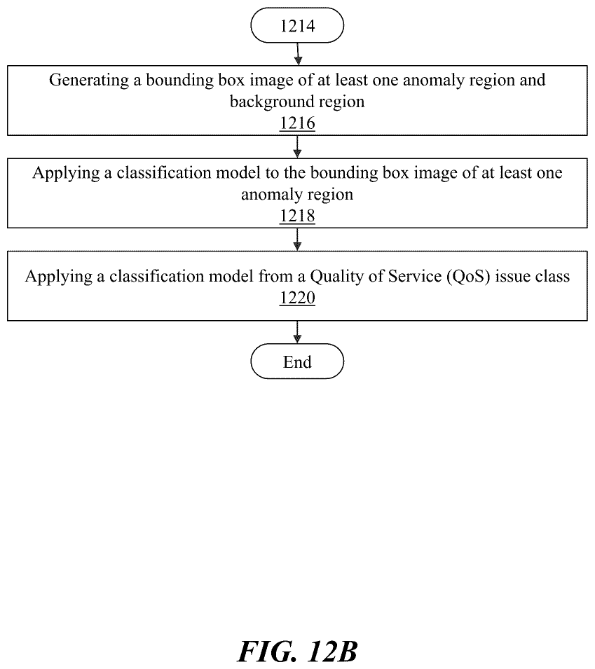

FIGS. 12A to 12B are a flowchart that further describes the method for processing a spectrum image measurement from FIG. 1, according to some embodiments of the present disclosure. In some embodiments, at 1202, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1204, averaging the anomalous power-frequency data set within each of the plurality of partitions at 1206, and generating a locally denoised graph image with at least one local anomaly region and a local background image at 1208. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1210, the method may include extracting contours of the at least one global anomaly region. At 1212, the method may include retrieving a convex hull of the contours of the at least one global anomaly region. At 1214, the method may include extracting bounding boxes from the convex hull of the contours of the at least one global anomaly region. At 1216, the method may include generating a bounding box image of at least one anomaly region and background region.

In some embodiments, at 1218, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a Quality of Service (QoS) issue class at 1220. In some embodiments, applying a classification model from a Quality of Service (QoS) issue class further comprises associating the Quality of Service (QoS) issue class with an underlying cause.

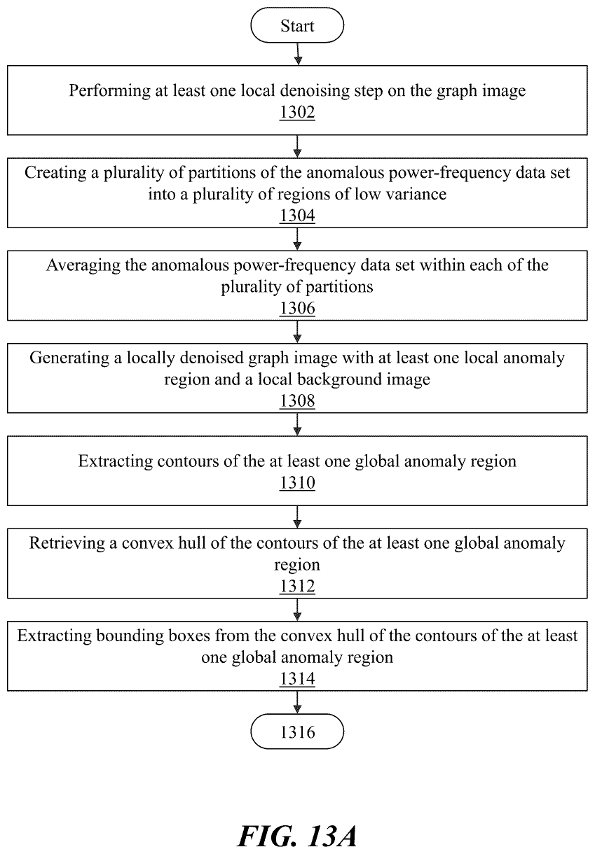

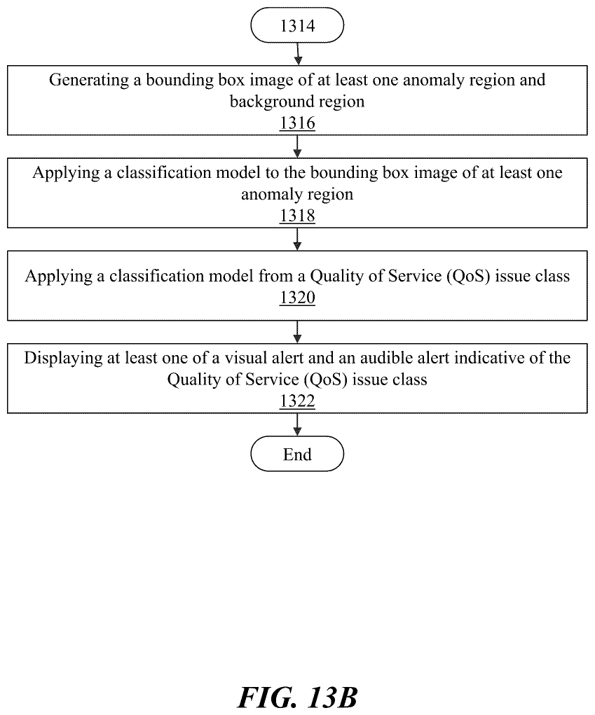

FIGS. 13A to 13B are a flowchart that further describes the method for processing a spectrum image measurement from FIG. 1, according to some embodiments of the present disclosure. In some embodiments, at 1302, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1304, averaging the anomalous power-frequency data set within each of the plurality of partitions at 1306, and generating a locally denoised graph image with at least one local anomaly region and a local background image at 1308. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1310, the method may include extracting contours of the at least one global anomaly region. At 1312, the method may include retrieving a convex hull of the contours of the at least one global anomaly region. At 1314, the method may include extracting bounding boxes from the convex hull of the contours of the at least one global anomaly region. At 1316, the method may include generating a bounding box image of at least one anomaly region and background region.

In some embodiments, at 1318, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a Quality of Service (QoS) issue class at 1320. In some embodiments, at 1322, the method may include displaying at least one of a visual alert and an audible alert indicative of the Quality of Service (QoS) issue class.

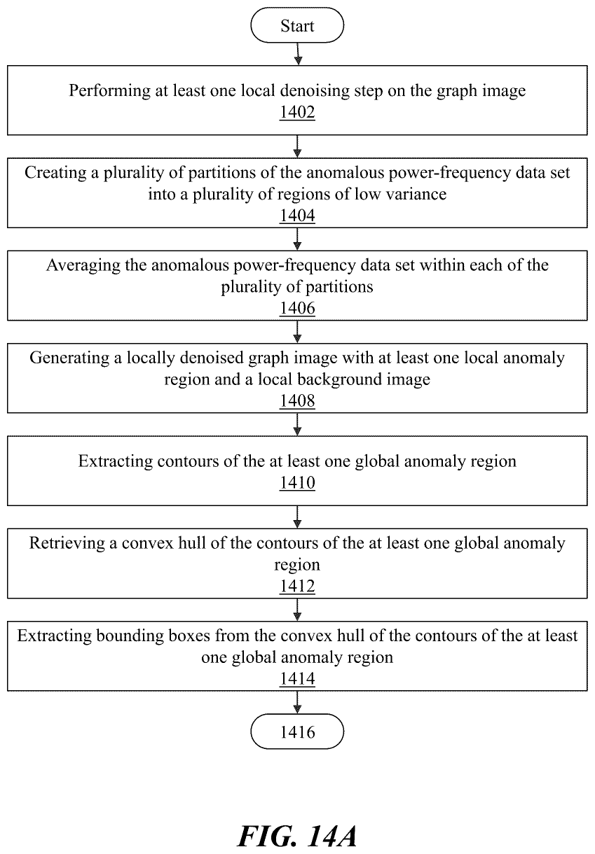

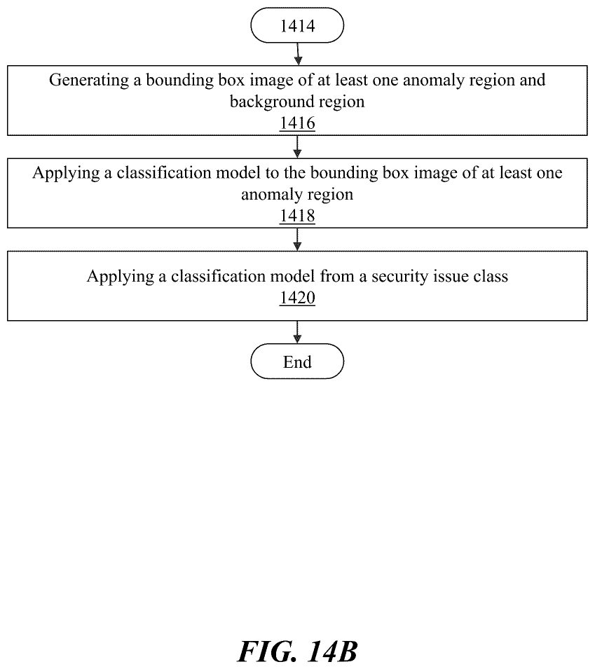

FIGS. 14A to 14B are a flowchart that further describes the method for processing a spectrum image measurement from FIG. 1, according to some embodiments of the present disclosure. In some embodiments, at 1402, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1404, averaging the anomalous power-frequency data set within each of the plurality of partitions at 1406, and generating a locally denoised graph image with at least one local anomaly region and a local background image at 1408. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1410, the method may include extracting contours of the at least one global anomaly region. At 1412, the method may include retrieving a convex hull of the contours of the at least one global anomaly region. At 1414, the method may include extracting bounding boxes from the convex hull of the contours of the at least one global anomaly region. At 1416, the method may include generating a bounding box image of at least one anomaly region and background region.

In some embodiments, at 1418, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a security issue class at 1420. In some embodiments, applying a classification model from a security issue class further comprises associating the security issue class with an underlying cause.

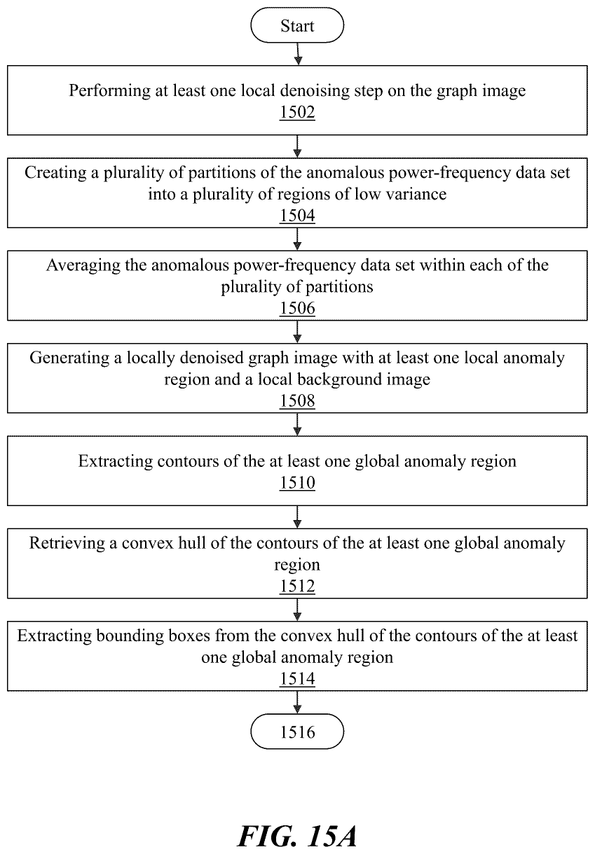

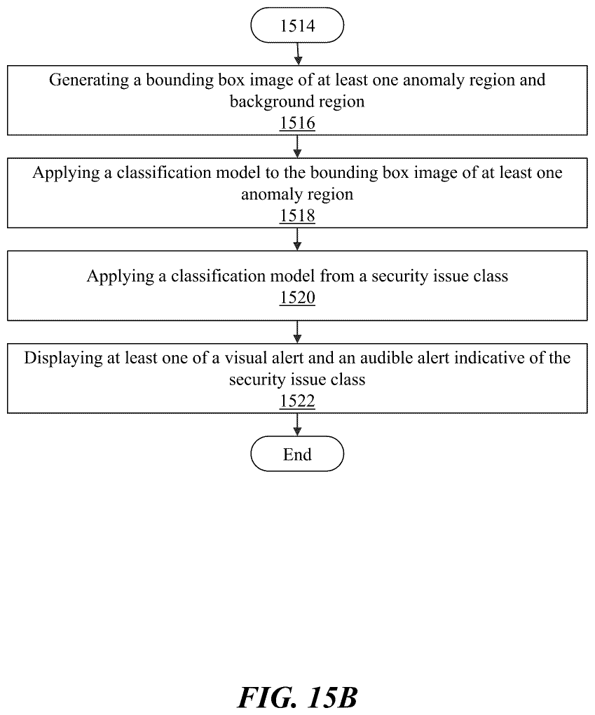

FIGS. 15A to 15B are a flowchart that further describes the method for processing a spectrum image measurement from FIG. 1, according to some embodiments of the present disclosure. In some embodiments, at 1502, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1504, averaging the anomalous power-frequency data set within each of the plurality of partitions at 1506, and generating a locally denoised graph image with at least one local anomaly region and a local background image at 1508. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1510, the method may include extracting contours of the at least one global anomaly region. At 1512, the method may include retrieving a convex hull of the contours of the at least one global anomaly region. At 1514, the method may include extracting bounding boxes from the convex hull of the contours of the at least one global anomaly region. At 1516, the method may include generating a bounding box image of at least one anomaly region and background region.

In some embodiments, at 1518, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a security issue class at 1520. In some embodiments, at 1522, the method may include displaying at least one of a visual alert and/or an audible alert indicative of the security issue class.

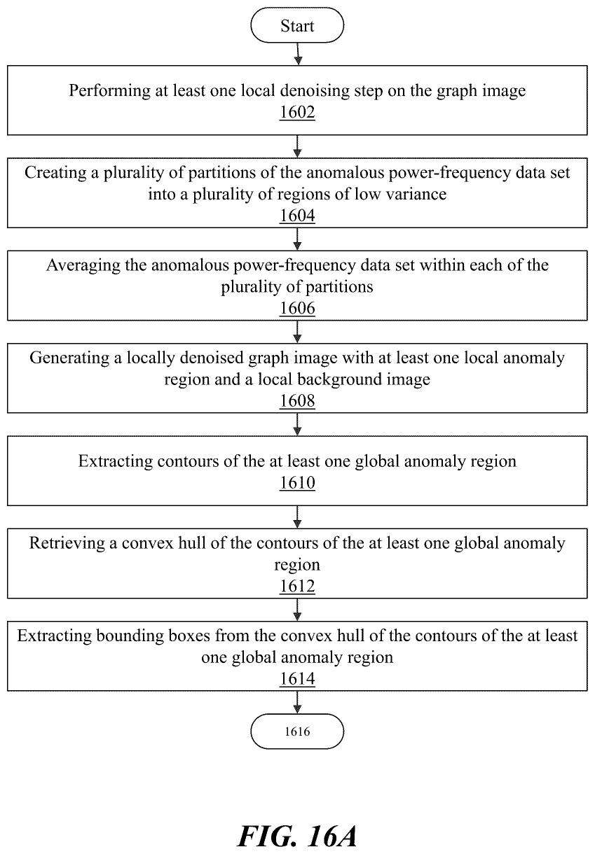

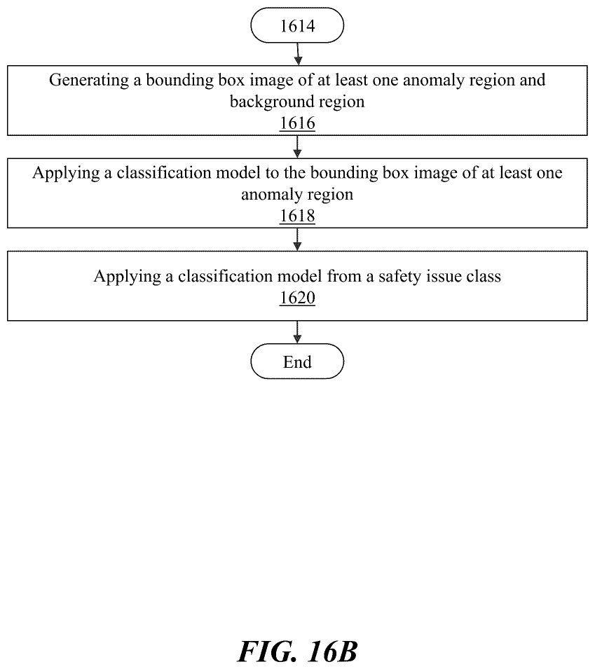

FIGS. 16A to 16B are a flowchart that further describes the method for processing a spectrum image measurement from FIG. 1, according to some embodiments of the present disclosure. In some embodiments, at 1602, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1604, averaging the anomalous power-frequency data set within each of the plurality of partitions at 1606, and generating a locally denoised graph image with at least one local anomaly region and a local background image at 1608. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1610, the method may include extracting contours of the at least one global anomaly region. At 1612, the method may include retrieving a convex hull of the contours of the at least one global anomaly region. At 1614, the method may include extracting bounding boxes from the convex hull of the contours of the at least one global anomaly region. At 1616, the method may include generating a bounding box image of at least one anomaly region and background region.

In some embodiments, at 1618, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a safety issue class at 1620. In some embodiments, applying a classification model from a security issue class further comprises associating the safety issue class with an underlying cause.

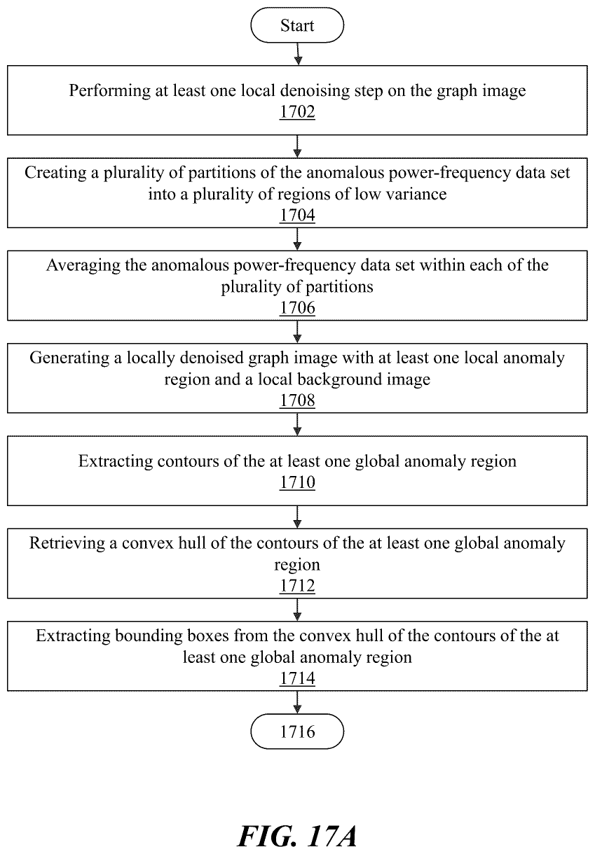

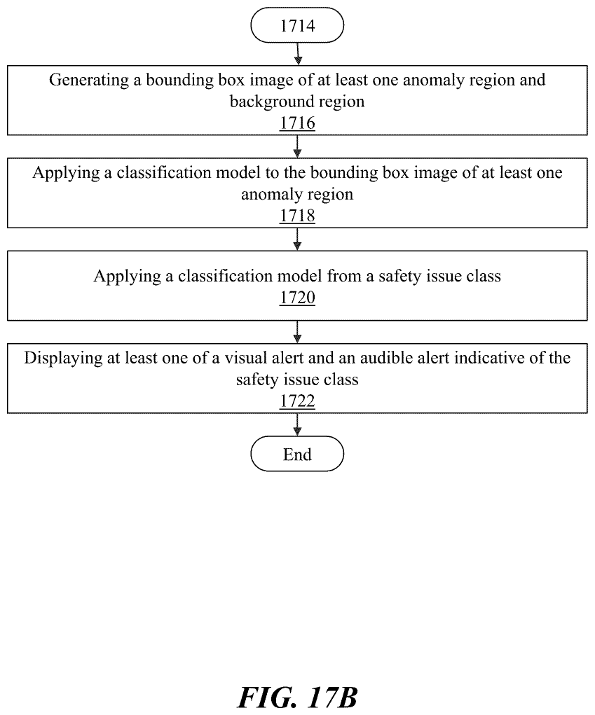

FIGS. 17A to 17B are a flowchart that further describes the method for processing a spectrum image measurement from FIG. 1, according to some embodiments of the present disclosure. In some embodiments, at 1702, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1704, averaging the anomalous power-frequency data set within each of the plurality of partitions at 1706, and generating a locally denoised graph image with at least one local anomaly region and a local background image at 1708 In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1710, the method may include extracting contours of the at least one global anomaly region. At 1712, the method may include retrieving a convex hull of the contours of the at least one global anomaly region. At 1714, the method may include extracting bounding boxes from the convex hull of the contours of the at least one global anomaly region. At 1716, the method may include generating a bounding box image of at least one anomaly region and background region.

In some embodiments, at 1718, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, associating the bounding box image of at least one anomaly region with at least one issue class further comprises applying a classification model from a safety issue class at 1620. In some embodiments, at 1722, the method may include displaying at least one of a visual alert and an audible alert indicative of the safety issue class.

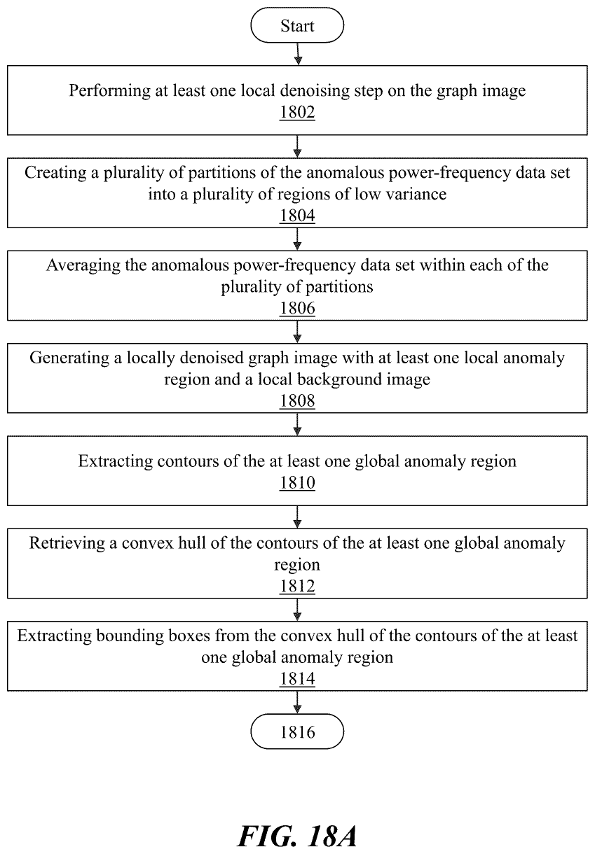

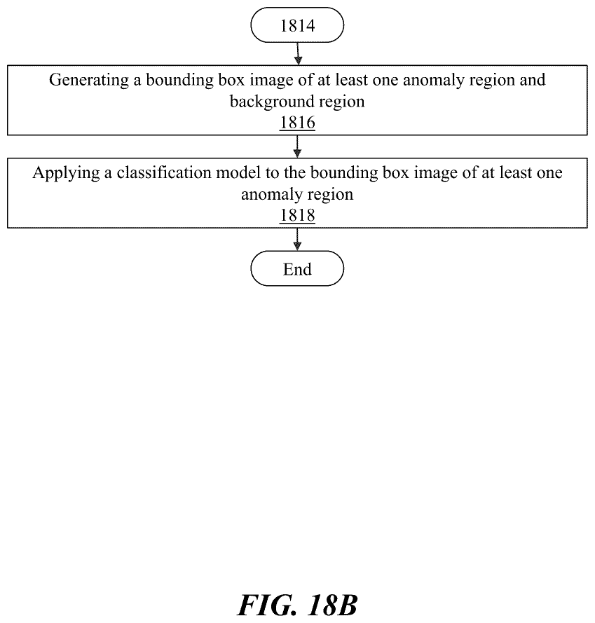

FIGS. 18A to 18B are a flowchart that further describes the method for processing a spectrum image measurement from FIG. 1, according to some embodiments of the present disclosure. In some embodiments, at 1802, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1804, averaging the anomalous power-frequency data set within each of the plurality of partitions at 1806, and generating a locally denoised graph image with at least one local anomaly region and a local background image at 1808. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 1810, the method may include extracting contours of the at least one global anomaly region. At 1812, the method may include retrieving a convex hull of the contours of the at least one global anomaly region. At 1814, the method may include extracting bounding boxes from the convex hull of the contours of the at least one global anomaly region. At 1816, the method may include generating a bounding box image of at least one anomaly region and background region.

In some embodiments, at 1818, the method may include applying a classification model to the bounding box image of at least one anomaly region. In some embodiments, applying a classification model to the bounding box image of at least one anomaly region further comprises associating the bounding box image of at least one anomaly region with at least one issue class. In some embodiments, applying a classification model from at least one of a Quality of Service (QoS) issue class, a Security issue class, a safety issue class, and/or a combination thereof.

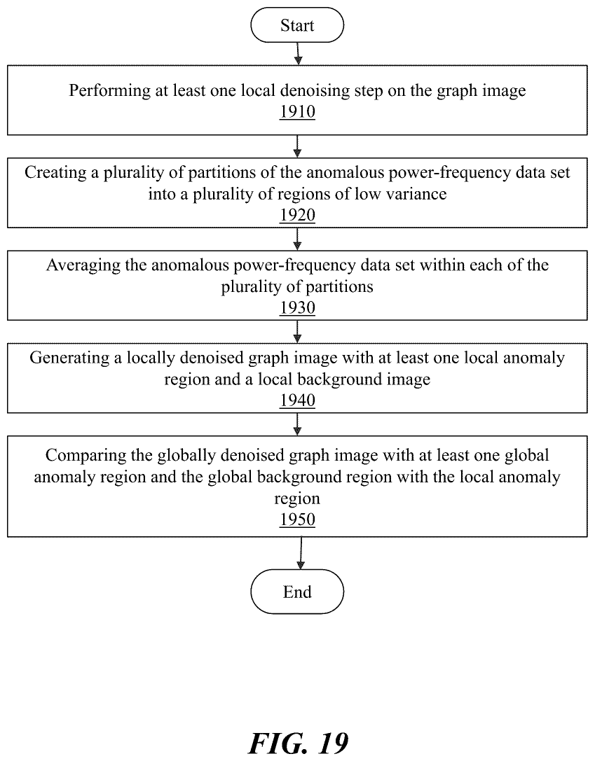

FIG. 19 is a flowchart that further describes the method for processing a spectrum image measurement from FIG. 1, according to some embodiments of the present disclosure. In some embodiments, at 1910, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 1920, averaging the anomalous power-frequency data set within each of the plurality of partitions at 1930, and generating a locally denoised graph image with at least one local anomaly region and a local background image at 1940. In some embodiments, performing at least one global denoising step on the locally denoised residual error image further comprises generating a globally denoised residual error image with at least one global anomaly region and a global background region. In some embodiments, at 1950, the method may include comparing the globally denoised residual error image with at least one global anomaly region and the global background region with the local anomaly region.

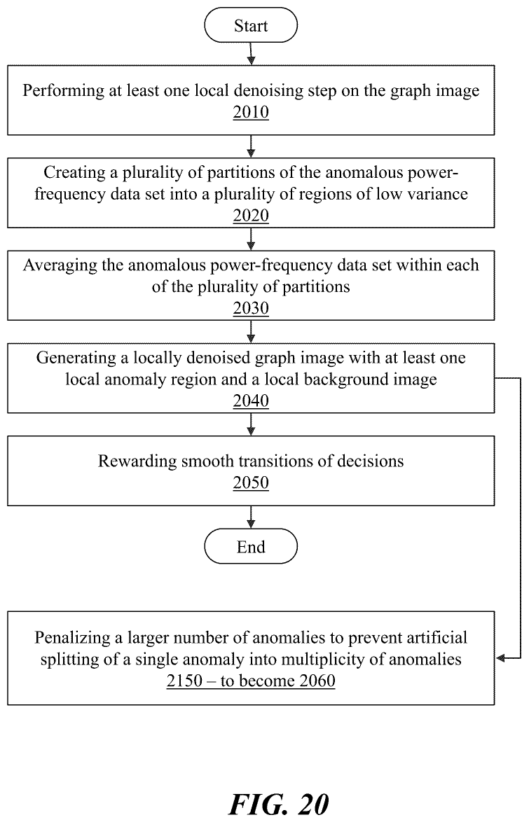

FIG. 20 is a flowchart that further describes the method for processing a spectrum image measurement from FIG. 1, according to some embodiments of the present disclosure. In some embodiments, at 2010, the method may include performing at least one local denoising step on the residual error image. In some embodiments, the performing at least one local denoising step on the residual error image further comprises creating a plurality of partitions of the anomalous power-frequency data set into a plurality of regions of low variance at 2020, averaging the anomalous power-frequency data set within each of the plurality of partitions at 2030, and generating a locally denoised graph image with at least one local anomaly region and a local background image at 2040. In some embodiments, performing at least one global denoising step on the locally denoised residual error image further comprises generating a globally denoised residual error image with at least one global anomaly region and a global background region. In some embodiments, at 2050, the method may include rewarding smooth transitions of decisions. In some embodiments, performing at least one global denoising step on the locally denoised residual error image further comprises generating a globally denoised residual error image with at least one global anomaly region and a global background region. In some embodiments, at 2060, the method may include penalizing a larger number of anomalies to prevent artificial splitting of a single anomaly into a multiplicity of anomalies (e.g., into multiple anomalies). In some embodiments, at 2060, the method may further include performing at least one global denoising step on the locally denoised residual error image.

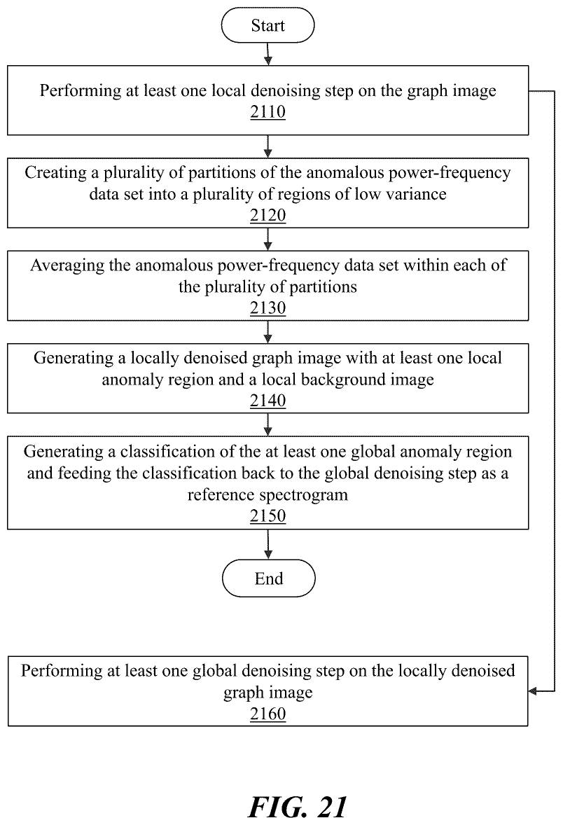

FIG. 21 is a flowchart that further describes the method for processing a spectrum image measurement from FIG. 1, according to some embodiments of the present disclosure. In some embodiments, at 2110, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 2120, averaging the anomalous power-frequency data set within each of the plurality of partitions at 2130, and generating a locally denoised graph image with at least one local anomaly region and a local background image at 2140. In some embodiments, performing at least one global denoising step on the locally denoised residual error image further comprises generating a globally denoised residual error image with at least one global anomaly region and a global background region. In some embodiments, at 2150, the method may include generating a classification of the at least one global anomaly region and feeding the classification back to the global denoising step as a reference spectrogram. In some embodiments, at 2160, the method may include performing at least one global denoising step on the locally denoised residual error image.

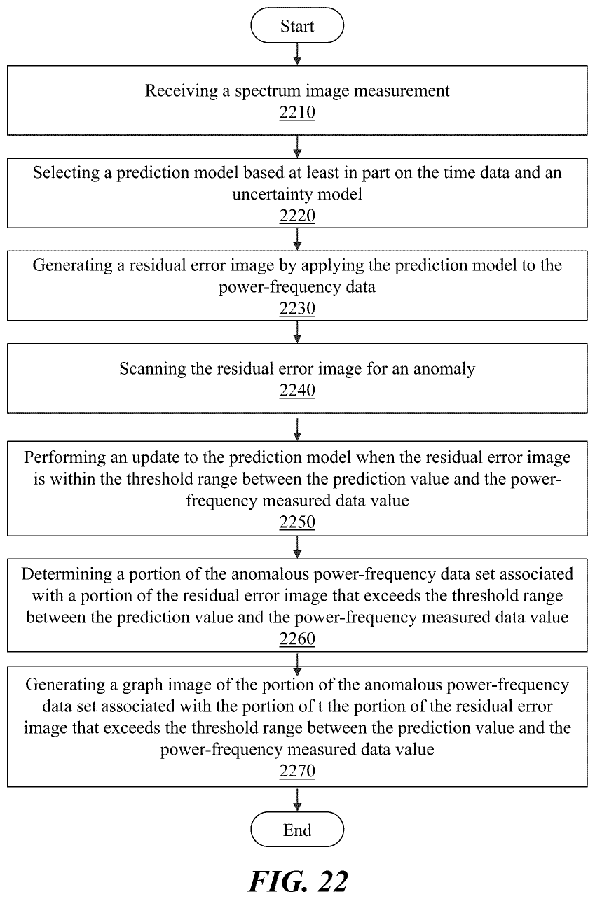

FIG. 22 is a flowchart that describes a method for processing a spectrum image measurement, according to some embodiments of the present disclosure. In some embodiments, at 2210, the method may include receiving a spectrum image measurement. At 2220, the method may include selecting a prediction based at least in part on the time data and an uncertainty model. At 2230, the method may include generating a residual error image by applying the prediction to the power-frequency data. At 2240, the method may include scanning the residual error image for an anomaly.

In some embodiments, at 2250, the method may include performing an update to the baseline prediction to an updated prediction when the residual error image may be within the threshold range between the prediction value and the power-frequency measured data value. At 2260, the method may include determining a portion of the anomalous power-frequency data set associated with a portion of the residual error image that exceeds the threshold range between the prediction value and the power-frequency measured data value. At 2270, the method may include generating a residual error image of the portion of the anomalous power-frequency data set associated with the portion of the residual error image that exceeds the threshold range between the prediction value and the power-frequency measured data value. The spectrum image measurement may comprise a plurality of power-frequency data values as a function of time and time data. An anomaly may be based at least in part on a portion of the residual error image exceeding a threshold range between a prediction value and the power-frequency measured data value. In some embodiments, generating a residual error image by applying the prediction to the power-frequency data further comprises applying a denoising technique. In some embodiments, generating a residual error image by applying the prediction to the power-frequency data further comprises combining anomalous spectrogram regions.

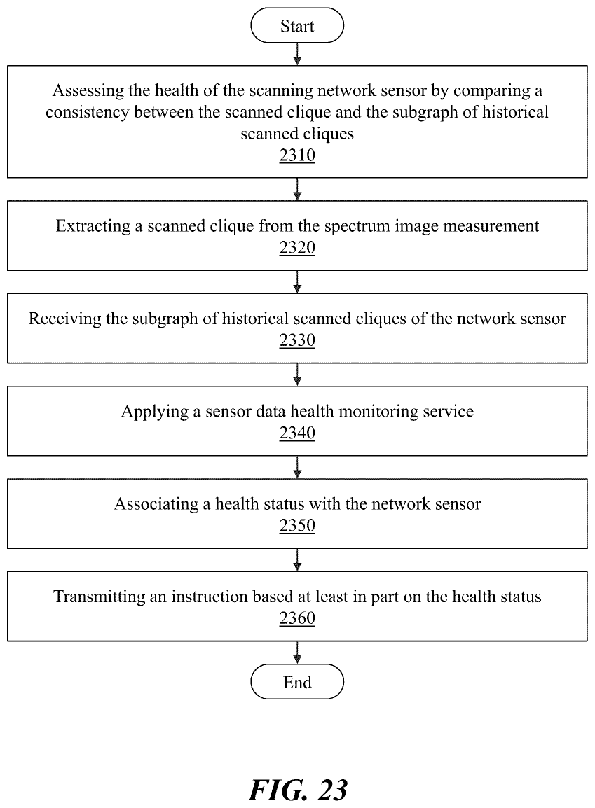

In some embodiments, selecting a prediction may be further based on an attribute of a scanning network sensor. In some embodiments, an attribute of a scanning network sensor may be a maintained subgraph of historical scanned cliques. FIG. 23 is a flowchart that further describes the method for processing a spectrum image measurement from FIG. 22, according to some embodiments of the present disclosure. In some embodiments, selecting a prediction may be further based on an attribute of a scanning network sensor. In some embodiments, an attribute of a scanning network sensor may be a maintained subgraph of historical scanned cliques. In some embodiments, at 2310, the method may include assessing the health of the scanning network sensor by comparing a consistency between the scanned clique and the subgraph of historical scanned cliques. In some embodiments, assessing the health of the scanning network sensor by comparing a consistency between the scanned clique and the subgraph of historical scanned cliques further comprises extracting a scanned clique from the spectrum image measurement at 2320, receiving the subgraph of historical scanned cliques of the network sensor at 2330, and applying a sensor data health monitoring service at 2340. The sensor data health monitoring service may determine a consistency between the scanned clique and the subgraph of historical scanned cliques of the network sensor. In some embodiments, at 2350 the method may include associating a health status with the network sensor, and at 2360 the method may include transmitting an instruction based at least in part on the health status.

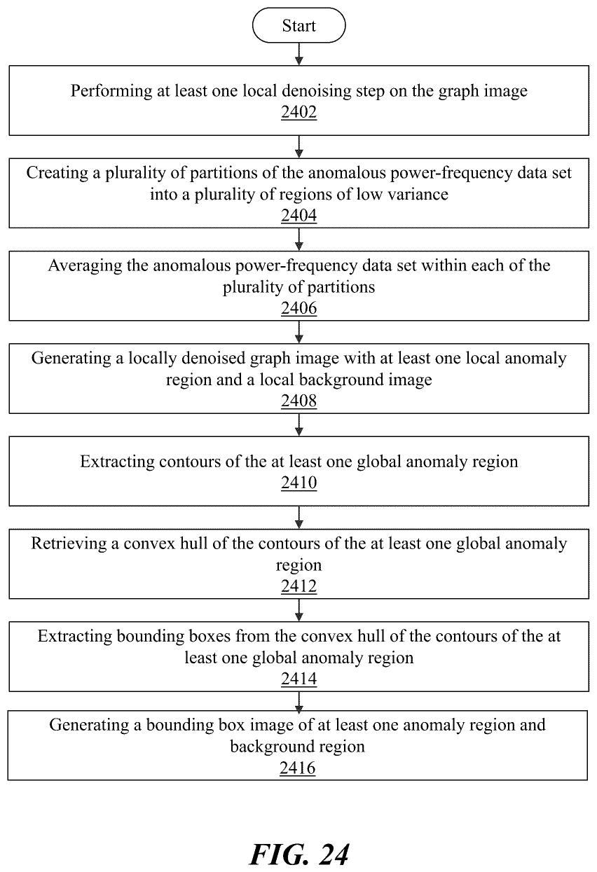

FIG. 24 is a flowchart that further describes the method for processing a spectrum image measurement from FIG. 22, according to some embodiments of the present disclosure. In some embodiments, at 2402, the method may include performing at least one local denoising step on the residual error image (e.g., graph image). In some embodiments, the performing at least one local denoising step on the residual error image further comprises creating a plurality of partitions of the anomalous power-frequency data set into a plurality of regions of low variance at 2404, averaging the anomalous power-frequency data set within each of the plurality of partitions at 2406, and generating a locally denoised graph image with at least one local anomaly region and a local background image at 2408. In some embodiments, performing at least one global denoising step on the locally denoised residual error image further comprises generating a globally denoised residual error image with at least one global anomaly region and a global background region.

In some embodiments, generating the globally denoised residual error image based at least in part on the globally optimal segmentation solution on the locally denoised residual error image further comprises extracting at least one bounding box of the at least one global anomaly region. In some embodiments, at 2410, the method may include extracting contours of the at least one global anomaly region. At 2412, the method may include retrieving a convex hull of the contours of the at least one global anomaly region. At 2414, the method may include extracting bounding boxes from the convex hull of the contours of the at least one global anomaly region. At 2416, the method may include generating a bounding box image of at least one anomaly region and background region.

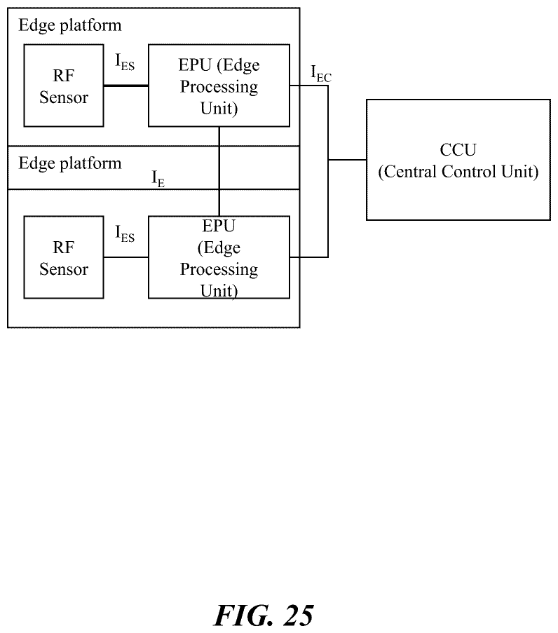

FIG. 25 is a circuit diagram of a distributed circuit architecture suitable to implement any one or more of the functions, operations, and/or other items disclosed herein, their equivalents, and/or any related functions, operations, and/or other items, according to embodiments. Furthermore, the distributed circuit architecture may be able to perform functions, operations, and/or other items not disclosed herein.

Regarding a distributed architecture:
Embodiments may include implementing dynamic allocation of computational tasks, from central unit to edge servers or to the sensors' computational units. Such dynamic allocation may be driven by real time probing of systems resources loading, such as CPU load, or by communication links' bandwidth availability or occupancy.
Embodiments may also include splitting the computational tasks between center and edge servers in such a way that model training will be done centrally while inference and anomaly detection will be done on the various edge servers.
Embodiments may also include implementing a sensor-based RF emitter localization technique (e.g. TDOA) based on inter-sensor traffic relay in order to save backhaul traffic from the sensors to the central core system in case of backhaul link capacity storage.

Abilities and structures that the distributed architecture of FIG. 25 may have include:

### Distributed Architecture

I_{E}-Edge interface
I_{ES}-Edge—Sensor interface
I_{EC}-Edge—Center interface
EPU main functions:
   RF scan
   Signal discovery and initial classification
   Baseline and anomaly detection
   Inter EPU scenario-localization
   Localization support for CCU

### Distributed Architecture Abilities

Main scope:
   1. Implement AI/ML algorithms for spectrum monitoring/management and distributed compute environment (Sensor-Edge-Core)
Objectives:
   1. Offload compute load from central unit
   2. Enable faster response time for local (edge) based applications for RF anomalies detection (by moving compute tasks closer to sensor/edge when possible)
   3. Integration with wide variety of sensing sources by creating an open API (IES interface)
System functions:
   1. System will check commute resources availability and status in the different platforms (sensor-edge-core) and will automatically optimize processing workload between center and edge depending on available compute resources.
   2. Optional optimize of bandwidth (BW) for transmitting information from edge to center depending on available BW resources
   3. The optional optimization may be done based on:
      1. Available resources
      2. Available BW
      3. User policies
      4. Tasks to be done (location, detection, classification, type of mission etc).

### Distributed Architecture—Artificial Intelligence (AI)

In cases where the number of sensors may be large (e.g., several hundreds and more), the computational burden on the main processing unit may increase significantly.
Sometimes the computational resources in the central unit are limited and part of the computation is done on the edge servers\sensors
There are many options how to split computation over the overall system between the edge server and the central unit
   Train each model on the central system, perform the inference\anomaly detection on the edge server.
   Train a unified bottle and adapt perimeters to each sensor (the last task is operated on the edge server)
   Localization: if the sensors can communicate, the physical measures associated with the localization process (e.g., TDOA) can be computed at the edge saving network traffic of >400 Mbps In the case of LTE to the central unit

### Distributed Architecture Example—Localization Optimization

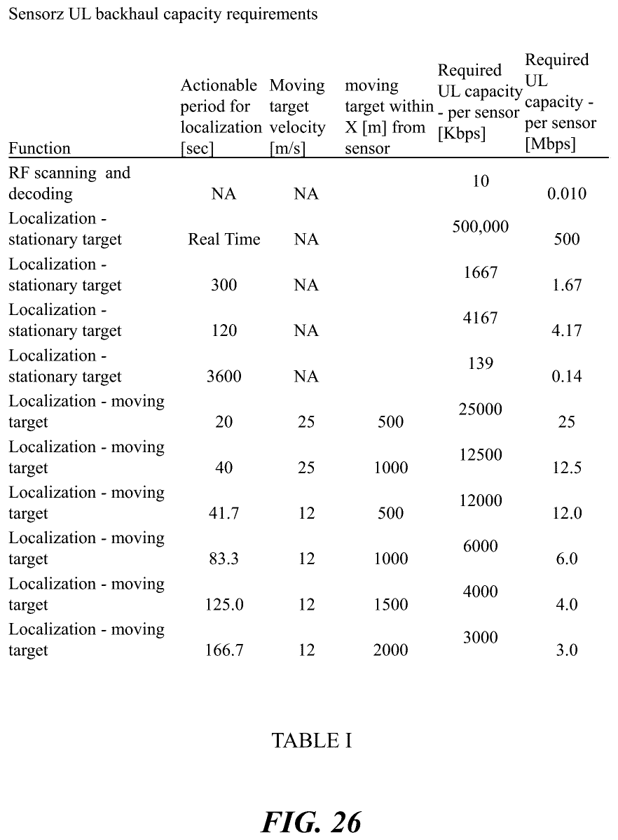

Localization accuracy might require different BW from the sensors.
   FIG. 26 is an example Table I showing some tradeoffs.
   Example: One needs 25 Mbps uplink (UL) BW from a single sensor to support localizing a moving target moving in a velocity of 25 m/s (90 kmph) with a delay of 20 seconds.

A distributed architecture may enable optimizing the workload according to the tasks and available BW and processing resources optimizations may be done by a central scheduler function residing in the core, which will be “aware” of resource status and may be triggered by anomalies and detections.

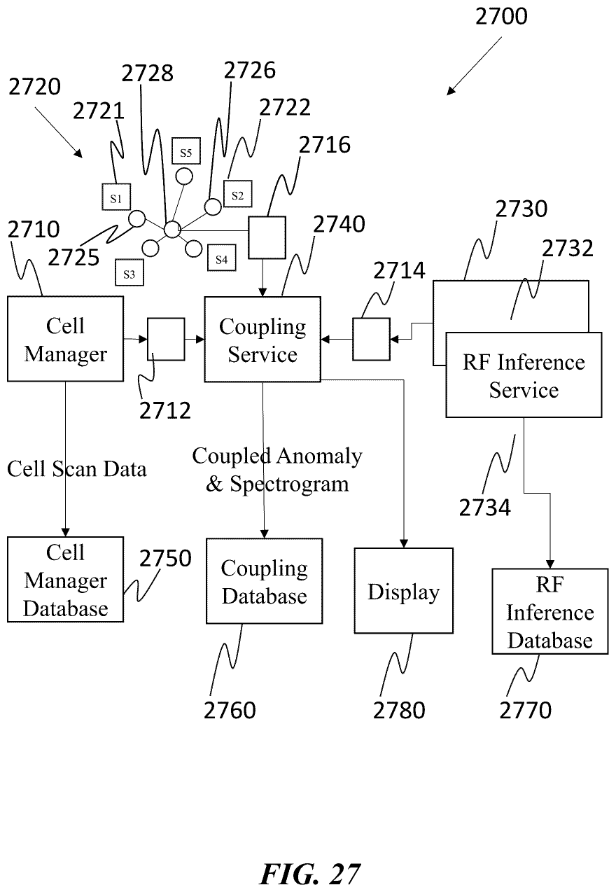

FIG. 27 depicts a preferred network 2700 for determining that a suspected anomalous event detected by different sources 2710, 2720, and 2730 is anomalous behavior. In some embodiments a cell manager 2710 may detect a suspected anomalous event on a cellular network. For illustrative purposes, the cell manager 2710 monitors a cellular network such as a 2G GSM, 3G UMTS, 4G LTE, 5G NR network, or the like.

At the highest level, a cell manager 2710 may be any network management system (NMS) that can be used to monitor devices on the network 2700. A network manager could detect CGI (Cell Global Identity) data, RSSI (Received Signal Strength Indicator)/RSRP (Reference Signal Received Power) data, ARFCN (Absolute Radio Frequency Channel Number) data, RAT (Radio Access Technology) data, a sensor identification (ID), and timestamp information by using a combination of network monitoring tools, specialized software, and hardware capabilities of the cell manager 2710.

For illustrative purposes, the Cell Global Identity (CGI) is a unique identifier for each cellular base station. CGI data may include information about the country, mobile network, location area, and the cell ID. This information can be obtained from a network base station of the cellular manager 2710 itself or from a mobile device connected to the cellular manager 2710. For illustrative purposes, RSSI data is a measure of the power level that a RF client device is receiving from an access point, whereas RSRP is a specific measurement used in LTE networks to evaluate signal strength. Both can be measured using specialized network monitoring equipment associated with or otherwise connected with or in communication with the cellular manager 2710 or software running on a mobile device associated with the cellular manager 2710. For illustrative purposes, ARFCN (Absolute Radio Frequency Channel Number) data is a code that specifies a pair of reference frequencies used for transmission and reception in radio network 2700. In mobile communications, ARFCN data can be used to determine the exact frequency of the band on which a cellular phone, for example, is operating. This ARFCN data can be obtained from a mobile device's service menu or using specialized software associated with the cellular manager 3310. For illustrative purposes, Radio Access Technology (RAT) data is the type of network technology (2G, 3G, 4G, 5G) used in communication between a mobile device and the base station associated with the cellular manager 3310. The RAT data can be determined from the device's network settings or with the use of network monitoring software associated with the cellular manager 2710. For illustrative purposes, timestamp data may be a measure of a time interval in which a potential anomalous event occurred, such as when a device connected to a base station. Timestamp data can be logged by the broadcasting device itself, the base station, or by network monitoring software in communication with the cellular manager 2710.

While the network management system (NMS) is depicted as a cellular manager 3110, alternative NMSs may be selected based on the frequency used in the network. For example, when the network 3100 is an Industrial, Scientific, and Medical (ISM) network, the cellular manager 2710 would be substituted with an appropriate NMS monitoring device. For example, the cellular manager 3110 may be a spectrum analyzer, a Wi-Fi analyzer, an RF explorer, a network analyzer, or a Software Defined Radio (SDR).

The network 2700 may also include a sensor network graph 2720. A sensor network graph 2720 is a mathematical model used to represent a wireless sensor network 2700. In this model 2720, each sensor 2721 and 2722 in the network 2700 is represented by a node (or vertex) 2725 and 2726, and the communication links between sensors are represented by edges (or arcs) 2728 connecting these nodes 2725 and 2726. For illustrative purposes, a node 2725 and 2726 typically represents a sensor. Each sensor in the network 2700 has a corresponding node 2725 and 2726 in the sensor network graph 2720. The location of the node 2725 and 2726 may represent the physical/geographical location of the sensor in the network 2700. For illustrative purposes, an edge 2728 in a sensor network graph 2720 represents a communication link between two sensors 2721 and 2722. If an edge 2728 exists between two nodes 2725 and 2726, that means those two sensors 2721 and 2722 can directly communicate with each other.

Properties of these nodes 2725 and 2726 and edges 2728 can be used to represent various features of the network 2700. For instance, the weight on an edge 2728 could represent the quality of the communication link between two sensors 2721 and 2722, or the distance between them 2721 and 2722. Sensor network graphs 2720 are commonly used in the analysis and design of wireless sensor networks. Sensor network graphs 2720 can be used to study properties like connectivity, coverage, energy consumption, data routing, and network resilience. Different types of graphs 2720 (e.g., directed, undirected, weighted, etc.) can be used depending on the specific characteristics of the network 2700 being modeled. A variety of tools may be used to create a sensor network graph 2720, depending on the modeling need and network 2700 attributes. Some options for developing a sensor network graph 2720 include network visualization tools like Gephi or Cytoscape, programming languages with strong data visualization libraries like Python (with NetworkX, Matplotlib, or Plotly), R (with iGraph or ggraph), or JavaScript (with D3.js), or even general-purpose graphing or drawing software.

Sensor network graphs 2720 may be used to model sensors geographical cliques, for example sensors 2721 and 2722 that provide similar or overlapping geographical coverage of the network 2700. In graph theory, a clique is a subset of vertices of an undirected graph such that every two distinct vertices in the clique are adjacent. As depicted in FIG. 27, every node 2725 is directly connected to every other node 2726, forming a fully connected subset. A “sensor clique” may refer to a group of sensor nodes 2725 and 2726 where each sensor node 2725 and 2726 is directly communicating with every other sensor in that group 2720.

In some embodiments, sensors 2721, 2722 may be related based on geographical location data or other similarities among them, for example, a common attribute such as a cell global identifier (CGI). A Cell Global Identifier (CGI) is a globally unique identifier for a Base Transceiver Station in a cellular network 2700. The CGI can be used to identify a particular cell (or sector of a cell) within a network 2700. The CGI is typically composed of the following attributes; a Mobile Country Code (MCC), a Mobile Network Code (MNC), a Location Area Code (LAC), and a Cell Identity (CI).

In some embodiments, a Mobile Country Code (MCC) is a three-digit number that uniquely identifies the country of the network operator. For example, the MCC for the United States is 310-316, and for the United Kingdom it's 234-235. In some embodiments, a Mobile Network Code (MNC) is a two or three-digit number that, when combined with the MCC, uniquely identifies a network operator within a particular country. For example, in the US, AT&T has an MNC of 410. In some embodiments, a Location Area Code (LAC) is a 16-bit number that identifies a location area within the network operator's coverage area. A location area is often a group of cells that are treated as a single unit for certain network operations, such as paging. In some embodiments, a Cell Identity (CI) is a 16-bit (for 2G) or 28-bit (for 3G, 4G, and 5G) number that uniquely identifies a particular cell within a location area.

In combination, the four attributes of a CGI allow any cell in the world to be uniquely identified. For example, a CGI might look something like this: MCC=310, MNC=410,LAC=12345, CI=67890, representing a specific cell in AT&T's network in the United States. In LTE and 5G NR systems, E-UTRAN Cell Identifier (ECI) and NR Cell Identifier (NCI) are used, respectively. These cell identifiers incorporate additional parameters and offer greater bit lengths for finer granularity of identification. These cell identifiers allow for a unique identification of a cell in a global context. While the four components of the CGI have been described, one having ordinary skill in the art will recognize opportunities to apply conventional techniques to the four components characterizing the graph sensor network 2720. For example, a Public Land Mobile Network (PLMN) is a network established and operated by an administration or by a recognized operating agency (ROA) for the specific purpose of providing land mobile telecommunications services to the public. In terms of its components within a CGI, the PLMN may be specified by the combination of the Mobile Country Code (MCC) and the Mobile Network Code (MNC). Such a combination provides information on a specific mobile network (e.g., Vodafone, AT&T) and a specific location (e.g., USA, UK, China, Israel).

In some embodiments, a sensor clique may refer to a subset of sensors 2721, 2722 that are all similar to each other. Such a relationship amongst sensors 2721, 2722 may be depicted in the sensor network graph 2720 with an edge 2728 between each sensor pair 2721, 2722.

In some embodiments, the sensor network graph 2720 may be used to detect suspected anomalous behavior as described in the present disclosure. Upon the detection of a suspected anomalous event, the sensor network graph 2720 may transmit a sensor network notification 2716. In some embodiments, the sensor network notification 2716 may include CGI data and a spectral measurement including a suspected anomaly.

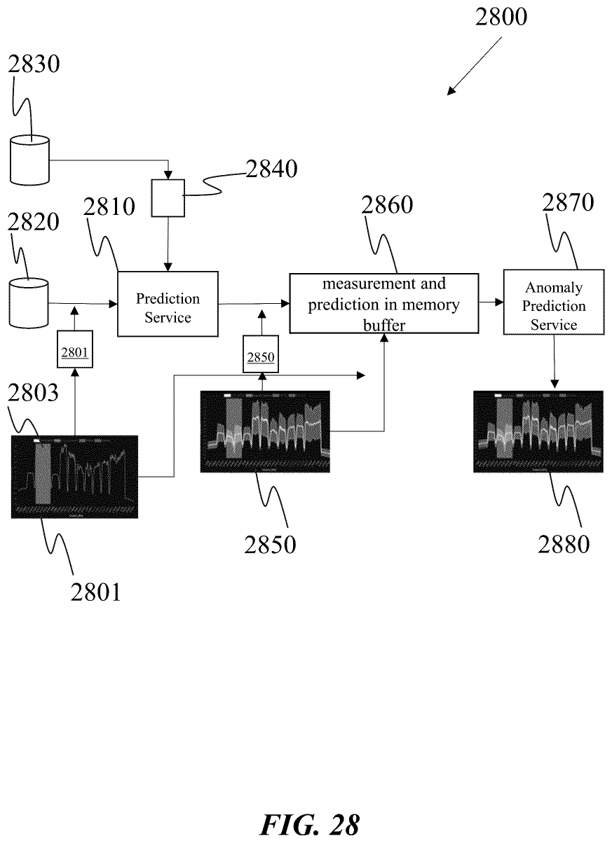

In some embodiments, the network 2700 may include an RF inference service 2730. An RF inference service may be used to detect anomalous behavior on the network 2700 and transmit an anomaly notification 2714 when a suspected anomalous event is detected on the network. The anomaly notification 2714 may include RF inference data. RF inference data may include frequency data, time stamp data, prediction data, a spectral measurement, a spectral variance, and sensor identification data. A network 2700 may include a broad spectrum of frequencies. In some embodiments, the network 2700 may be monitored by a plurality of RF inference services 2730, 2732, and 2734. Multiple inference services 2730, 2732, and 2734 may be used to monitor different geographical regions within the network 2700, different frequency domains within the network 2700, or redundant spectral monitoring services. An exemplary RF inference service flow 2800 is discussed with respect to FIG. 28.

In some embodiments, a potential anomaly may be detected by the cellular manager 2710, the sensor network graph 2720, and the RF inference service 2730. As may be appreciated, each system 2710, 2720, 2730 may detect a potential anomaly synchronously or asynchronously. In a preferred embodiment, each system 2710, 2720, 2730 may recognize the suspected anomaly and transmit an anomaly notification 2712, 2716, and 2714 respectively to a coupling service 2740. Upon detection of a potential anomaly, the cell manager 2710 may compare the potential anomaly against historical data of known anomalous behavior stored in a cell manager database 2750. Similarly, upon detection of a potential anomaly, the RF inference service 2730, 2732, 2734 may compare the potential anomaly against historical data of known anomalous behavior stored in a RF inference database 2770. Upon confirmation of anomalous behavior, the cell manager 2710 and RF inference service 2730, 2732, 2734 will transmit anomaly notification 2712, 2716, and 2714 respectively to a coupling service 2740.

In some embodiments, the coupling service 2740 receives the transmitted anomaly notifications 2712, 2714, and 2716. In some embodiments, the coupling service may include a machine learning (ML) algorithm trained on rules and spectral measurements labeled implicitly by an anomaly manager. The coupling service 2740 matches, recognizes, or otherwise associates the anomalous behavior detected by the cell manager 2710, the sensor network graph 2720, and RF inference service 2730 using a matching algorithm. In some embodiments, the matching algorithm recognizes similarities amongst the subset of RF spectral data to recognize the same anomalous event detected from multiple services 2710, 2720, 2730. In some embodiments, the coupling service 2740 may associate anomalies detected by the RF inference service 2730 and the cell manager 2710. In some embodiments, the association may be accomplished by determining a high marching score between frequency ranges of the received power-frequency data. In some embodiments, the coupling service 2740 associates or recognizes anomalies detected by different sensors amongst the cell manager data by using CGI information. In some embodiments, the coupling service 2740 associates or recognizes radio frequency data from different sensors using CGI data or using high matching scores between detected frequency ranges. In some embodiments, an active anomaly queue supports an asynchronous update process of recognizing the same detected anomalies across multiple anomaly notifications.

In some embodiments, radio frequency (RF) information is used to classify behavior as anomalous behavior. An exemplary method may include the following steps:
Query RF DB based on the sensor cliques, i.e. ask for RF anomaly information from sensors that share a clique with the sensor at hand;
Query the CM DB for all sensors in the clique in the relevant time window;
Passing CM DB through a validation test (e.g., remove CM query if passes the validation test);
Extend CM Query with the same CGI query;
Passes through a cell (Rouge or new) test;
Passes through a jammer test;
Passes through a coverage hole test; and
If query results exceed an anomaly threshold, a matching algorithm of the coupling service 2740 transmits visual data indicative of an anomaly to a user interface (UI) of a display 2780 with an anomaly having the highest anomaly classification score.

A coupling service 2740 may include several inputs. In some embodiments, the coupling service 2740 includes anomaly notifications 2714 from multiple RF inference services 2730, 2732, 2734.

An exemplary RF inference service flow 2800 is depicted in FIG. 28. In some embodiments, the purpose of the RF service flow 2800 is to detect whether a spectrum image measurement 2801 contains an anomaly 2803 and applying an indication of an anomaly within the frequency region where an anomalous behavior is suspected. In some embodiments, the anomaly 2803 may be indicated using a boundary box, applying metadata to the spectrum image measurement 2801 indicating the location of the anomaly 2803, or applying a different color to the location of the anomaly 2803 in the spectrum image measurement 2801. In some embodiments, the location of the anomaly 2803 within the spectrum image measurement 2801 include a bounding box, a start time and end time during which the anomaly 2803 is present, and the frequency range within the band of the spectrum image measurement 2801.

To determine whether a detected anomaly 2803 is anomalous behavior, the spectrum image measurement 2801 is sent to a prediction model service 2810. The prediction model service 2810 may be aided by a historical spectrum image database 2820 and a model database 2830 containing predictor model parameters 2840. The prediction service 2810 may use each of the historical spectrum image database 2820 and the predictor model parameters 2840 to detect the anomaly 2803. In some embodiments the prediction service 2810 may transmit a prediction and uncertainty spectrum image data 2850 to a measurement and prediction un memory buffer 2860. In some embodiments, the prediction 2860 may include both a prediction and uncertainty determination before sending to the prediction un memory buffer 2860. Ultimately, the anomaly detection service 2870 matches the original spectrum image measurement 2801 and the prediction and uncertainty spectrum image data 2850 in an anomaly detection image 2880.

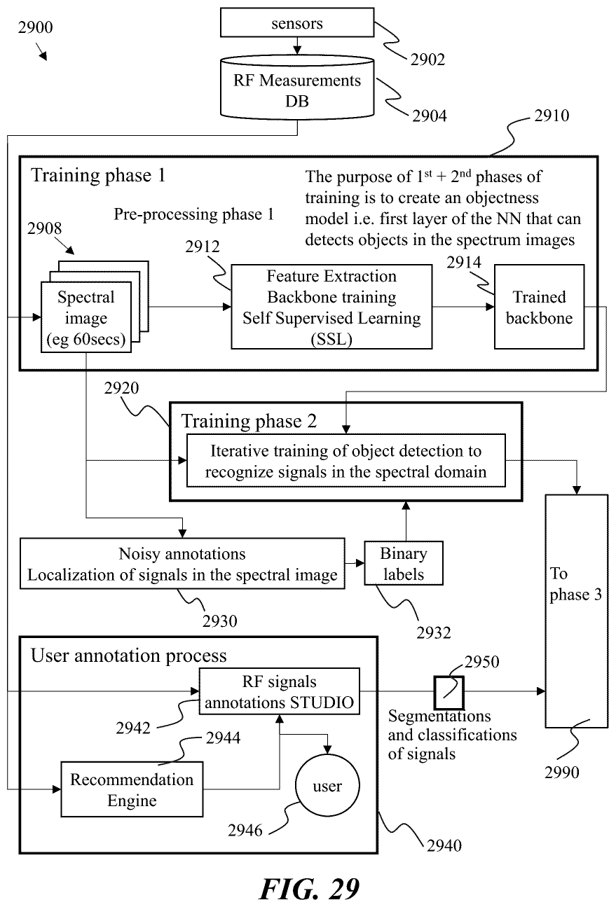

FIG. 29 illustrates a multi-phase training process 2900 for a neural network aimed at detecting and classifying spectral objects in PSD (Power Spectral Density) spectrogram images 2908. The process begins with sensors 2902 transmitting RF data to an RF Measurements Database 2904, where the data is stored and processed into PSD spectrogram images 2908. The system includes a first training phase 2910, a second training phase 2920, and a user annotation process 2940, which sequentially enhance the object detection and classification capabilities of the neural network.

In some embodiments, in the first training phase 2910, a feature extraction backbone 2912 is trained using self-supervised learning, producing a trained backbone 2914 capable of identifying invariant features in the PSD spectrogram images 2908. In the second training phase 2920, the object detection model undergoes iterative training to refine the localization of regions of interest (ROIs) within the spectral domain, using noisy annotations 2930 and binary labels 2932. During the first training phase 2910, the system 2900 processes power spectral density (PSD) spectrogram data 2908, which is received from one or more sensors 2902 and stored in the RF Measurements Database 2904. The PSD spectrogram images 2908 represent time-varying frequency power distributions within an RF spectrum and serve as the foundational input for training the neural network. In some embodiments, the neural network in the first training phase 2910 is trained to create an objectness model using self-supervised learning (SSL) 2912.

In some embodiments, the self-supervised learning process identifies invariant features within the PSD spectrogram data 2908 by leveraging augmented versions of the spectrograms. For example, the spectrogram data may be modified through domain-specific augmentations, such as random erasing, noise floor adjustments, or automatic gain control (AGC) simulation, to enhance the diversity of training data and improve feature extraction. These augmentations are applied during feature extraction process 2912 within the first training phase 2910, resulting in the trained backbone 2914. In some embodiments, the first phase 2910 outputs a trained backbone model 2914, which acts as the foundational layer of the neural network for further iterative refinement in the second phase 2920. The trained backbone ensures that the network can process diverse PSD spectrogram inputs 2908 and reliably detect key features in spectral images, with noisy annotations 2930 and binary labels 2932 supporting refinement during subsequent phases.

The neural network 2912 is trained to localize regions of interest (ROIs) within the PSD spectrogram data 2908, which represent potential areas containing spectral objects. By identifying these invariant features, the objectness model generated during training 2912 is able to generalize across different spectral environments, enabling it to detect and suggest ROIs within PSD spectrograms without prior retraining for specific sensors or frequency ranges.

In the second training phase 2920, the system refines the localization of regions of interest (ROIs) and classification of signals within the PSD spectrogram data 2908 by iteratively training the object detection model. This process uses noisy annotations 2930, which provide initial labeling of spectral data, and binary labels 2932, which define the presence or absence of specific signal classes within the spectral domain.

In some embodiments, the second training phase incorporates user-provided annotations gathered during the user annotation process 2940 to improve the detection model. These annotations are prioritized by a recommendation engine 2944, which clusters unknown signals and selects representative signals for annotation. By maintaining diversity in the clusters, the recommendation engine may minimize user effort while maximizing the quality of input for training.

The iterative training process leverages semi-supervised learning to refine the this paragraph is relevant to training phase 3 training phase 2 is just being mentioned in claim 152 so I would switch the order neural network, ensuring that previously identified classes are retained while incorporating new signal categories suggested by user annotations. For example, hierarchical classification techniques may be applied to organize signals into predefined families (e.g., cellular signals or public mobile radio signals). This hierarchical framework enables multi-level granularity, where known signals are mapped to categories, and unknown signals are flagged for further classification.

In some embodiments, the system 2900 associates hopping or intermittent signals across snapshots to identify individual emitters or sources within the RF spectrum. This entity identification capability supports emitter counting, allowing the system 2900 to estimate the number of sources operating in the vicinity of the sensor 2902. Such functionality can identify multiple interfering signals or characterize the RF environment during signal classification tasks.

The second training phase 2920 depicted in FIG. 29 focuses on iterative object detection training to localize signals in the spectral domain. In this phase, noisy annotations 2930 are utilized to train the model at an objectness level, ensuring robustness and preventing overfitting to the relatively small dataset generated by user annotations 2940. The noisy annotations 2930, which are automatically generated and processed efficiently, provide a large dataset for training, allowing the model to generalize better and improve its ability to localize signals across diverse spectral images.

This approach enables the model to exploit the user-annotated dataset more effectively during the subsequent fine-tuning phase. By training on a large volume of automatically generated noisy annotations, the system enhances its generalization capabilities and avoids severe overfitting to the user-annotated data. Binary labels 2932 derived during this phase further refine the localization of signals within the spectral image, ensuring that the trained backbone 2914 is well-prepared for subsequent stages of processing and classification.

The User Annotation Process 2940 is an integral stage in the iterative refinement of the neural network for spectral signal detection and classification, as illustrated in FIG. 29. This process leverages user-provided annotations to improve the localization and classification of signals within the spectral domain. The User Annotation Process 2940 begins with inputs from the RF Measurements DB 2904, which provides power spectral density (PSD) spectrogram data and other RF signal measurements. These measurements serve as the raw data for clustering and annotation.

The Recommendation Engine 2944 processes the signal data to cluster RF signals into representative groups based on features such as frequency, amplitude, and modulation patterns and also features retrieved from the neural network model. The clustering process prioritizes diversity within the selected signal groups while minimizing redundancy, allowing efficient user interaction. The Recommendation Engine 2944 identifies representative signals within each cluster and recommends them for annotation, reducing the manual workload for users.

The representative signals selected by the Recommendation Engine 2944 are presented to the user through the RF Signals Annotations STUDIO 2942. The RF Signals Annotations STUDIO 2942 serves as an interface that enables the User 2946 to label the signals, correct existing annotations, or flag unknown signals for further analysis. These user-provided annotations contribute to the refinement of the object detection and classification models.

The annotated signals from the RF Signals Annotations STUDIO 2942 are processed in the Segmentation and Classification of Signals 2950. This stage incorporates the user annotations to refine the localization of ROIs and improve the classification accuracy of the neural network. The updated segmentation and classification data are then used to retrain the neural network.

Throughout this process, the system 2900 iteratively incorporates user feedback to improve its detection and classification performance. The annotations provided by the User 2946 are used to refine the objectness model and enable the neural network to adapt to new or evolving signal categories. The process supports continuous improvement through semi-supervised learning, ensuring that the neural network can generalize to unseen signal types and environments.

In Training Phase Three (3) 2990, the system 2900 focuses on training the neural network to classify signals based on user-provided annotations and previously gathered spectral data. Training Phase Three (3) 2990 builds on the outputs of earlier training phases 2910 and 2920, incorporating refined annotations and expanding the neural network's ability to generalize across new and unknown signal classes.

During Training Phase Three (3) 2990, unknown signals that do not match predefined categories are flagged as “unknown” and categorized accordingly. The neural network utilizes annotated signal classes provided by the User Annotation Process 2940 and the Segmentation and Classification of Signals 2950 to train on new classes. By leveraging these new annotated signal classes, Training Phase 3 2990 ensures that the model continually evolves to account for changes in the RF environment or emerging signal types.

The iterative nature of Training Phase Three (3) 2990 allows the neural network to incorporate diverse signal annotations, enabling the model to accurately classify both previously known and newly introduced signal categories. This process ensures that the system 2900 adapts dynamically, maintaining its effectiveness in real-world deployments. Additionally, Training Phase Three (3) 2990 supports semi-supervised learning paradigms to retain knowledge of prior classifications while seamlessly integrating new data into the training process.

This structured workflow ensures that annotations generated during the User Annotation Process 2940 are integrated into the iterative training and refinement of the neural network. The connection between the RF Measurements DB 2904, Recommendation Engine 2944, RF Signals Annotations STUDIO 2942, User 2946, and Segmentation and Classification of Signals 2950 ensures the system 2900′s ability to improve its detection and classification capabilities in diverse RF environments. Brief definitions of terms used throughout this application are given below.

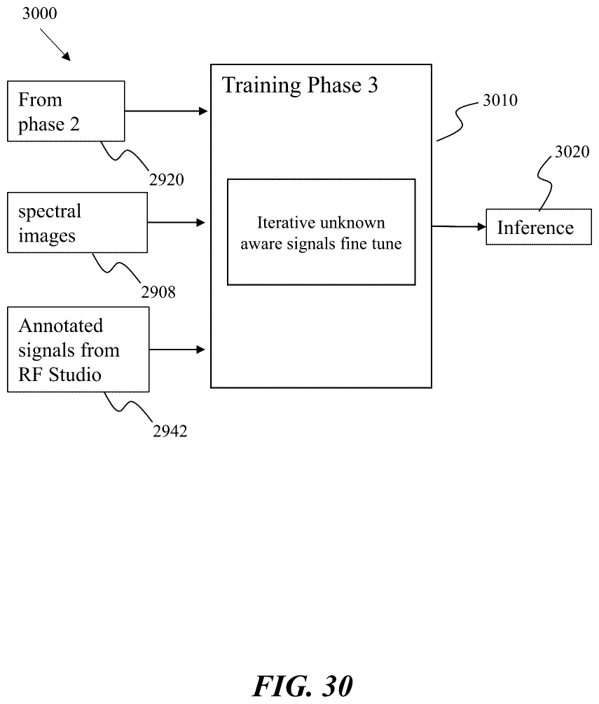

Turning now to FIG. 30, Training Phase Three (3) 3000 illustrates the process by which the system 2900 further trains the neural network to classify signals within the PSD spectrogram data 2908. This phase builds upon the object detection capabilities refined in Training Phase Two (2) 2920 and incorporates multiple data inputs and processes to enable comprehensive classification and refinement of the neural network.

Training Phase Three (3) 3000 receives inputs from several sources: 1) The refined object detection model generated during Training Phase Two (2) 2920. 2) Spectral images 2908, which represent time-varying frequency power distributions within the RF spectrum. 3) Annotated signals from RF Studio 2942, which include user-provided annotations identifying new signal classes.

In Training Phase Three (3) 3000, these inputs are processed through an iterative fine-tuning stage labeled as “Iterative unknown-aware signals fine-tune.” This stage trains the neural network to adapt to unknown signal types while retaining knowledge of previously identified signal classes. Annotated signals from RF Studio 2942 are used to incorporate new classes of signals into the neural network. Signals that cannot be mapped to predefined categories are flagged as “unknown” and added as new classes for further training.

The output of Training Phase Three (3) 3000 is a new model with new capabilities which is then applied to the Inference Module 3010, which applies the updated neural network to classify signals into predefined categories or newly identified classes. This inference step ensures that the model remains capable of responding to dynamic RF environments and classifies signals with improved accuracy.

Finally, the classified signals (e.g., the detected signals) are sent to the user interface (such as the UI within the user annotation process 2940 depicted in FIG. 29) and are also saved to the database for further and advanced analytics, where they are categorized and made available for further analysis. FIG. 30 demonstrates the iterative training process within Training Phase Three (3) 3000 and its integration with user-provided annotations and signal classification, as supported by claims related to user annotations, iterative learning, and classification of new signal types. This phase highlights the system's ability to adapt to evolving RF conditions by leveraging new signal data and user input to refine its detection and classification capabilities.

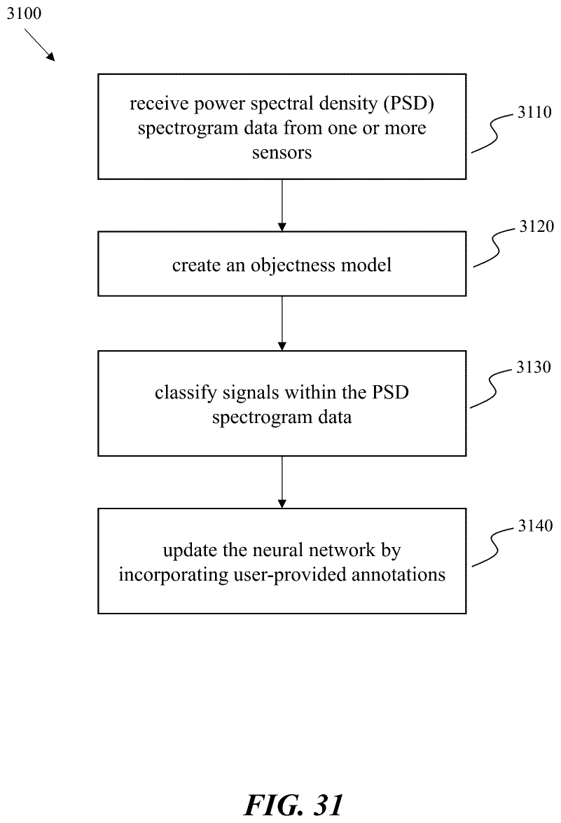

FIG. 31 depicts the sequence of steps in the method 3100, including receive power spectral density (PSD) spectrogram data from one or more sensors 3110, create an objectness model 3120, classify signals within the PSD spectrogram data 3130, and update the neural network by incorporating user-provided annotations 3140 to detect and classify spectral objects. The computer-implemented method 3100 for anomaly detection and classification of objects of interest comprises a sequence of steps that when executed by a processor, cause the processor to process power spectral density (PSD) spectrogram data and iteratively refine the neural network. FIG. 31 depicts processes executed by the processor, with instructions for signal detection and classification stored in memory. The processor, which may be local, remote, or distributed, ensures flexibility across different computational architectures and operational contexts.

In step 3110, the processor is configured to receive power spectral density (PSD)

spectrogram data from one or more sensors 3110. The PSD spectrograms represent time-varying frequency power distributions within an RF spectrum and are used as the input for subsequent processing.

In step 3120, the processor is configured to create an objectness model 3120 using a neural network through self-supervised learning. The objectness model identifies invariant features within the PSD spectrogram data and localizes regions of interest (ROIs) that may contain spectral objects. The objectness model operates without requiring retraining for specific sensors or frequency ranges.

In step 3130, the processor is configured to classify signals within the PSD spectrogram data 3130 based on the objectness model. Signals are categorized into predefined classes, and a hierarchical classification structure may be used. Known signals may be mapped to predefined families, such as cellular signals or public mobile radio signals, while unknown signals are flagged for further analysis. The classification framework provides multiple levels of classification granularity, allowing signals to be categorized at various levels within a hierarchy based on confidence scores.

In step 3140, the processor is configured to update the neural network by incorporating user-provided annotations 3140 into the training process. The system refines the neural network using semi-supervised learning, which adapts the model to new or evolving spectral environments. A recommendation engine may cluster RF signals and select representative signals for user annotation. These clusters are designed to maintain diversity and reduce the effort required for annotation. The user-provided annotations are incorporated into the objectness model to improve its ability to localize ROIs and classify signals within the PSD spectrogram data.

In some embodiments, the recommendation engine clusters unknown signals and recommends representative signals for annotation as new signal classes. The system can associate intermittent or hopping signals across snapshots, enabling identification of individual emitters or sources within the RF spectrum. This supports tasks such as counting the number of emitters or identifying multiple signal sources.

The system can trigger follow-up actions based on detected anomalies, such as activating direction finding (DF), recording signals, or communicating with third-party systems. User feedback on detected signals is used to further refine the model. In some embodiments, the system automatically triggers model retraining when a sufficient number of user annotations have been collected.

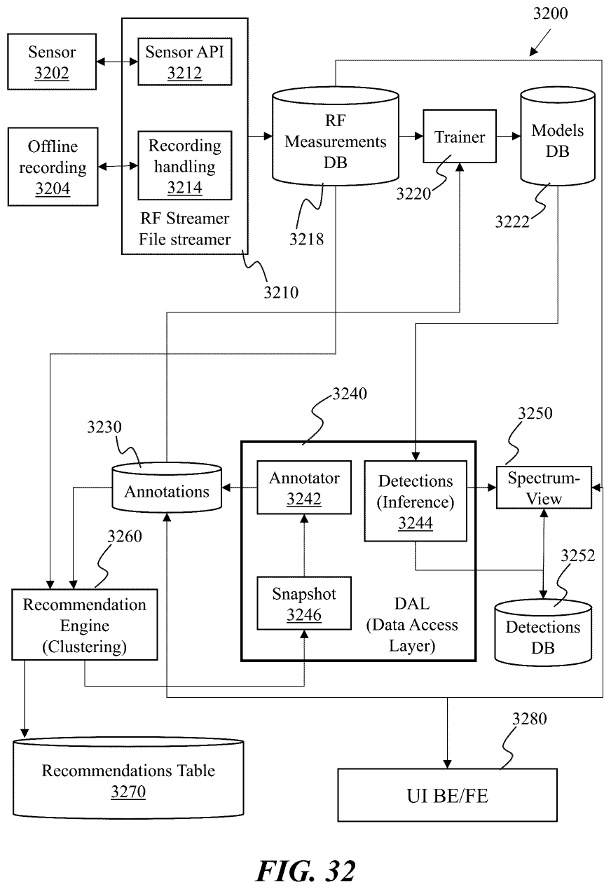

Turning now to FIG. 32, the figure depicts a system 3200 for processing power spectral density (PSD) spectrograms to detect and classify spectral objects, generate bounding boxes for localized regions of interest (ROIs), and support user annotations for iterative refinement of a neural network. The system 3200 includes several components that facilitate data ingestion, preprocessing, detection, classification, and annotation, with each step implemented by a processor executing instructions stored in memory. The processor may be configured to operate locally, remotely, or in distributed environments, enabling flexibility in deployment.

The system 3200 begins by receiving PSD spectrograms from at least one sensor 3202. PSD spectrograms represent time-varying frequency power distributions within an RF spectrum, serving as the foundational input for further processing. Sensors capture RF measurements, which are transmitted via a Sensor API 3212 or an offline recording mechanism 3204. The data is subsequently processed by the Recording handling component 3214 and streamed into the RF Measurements Database 3218, where raw data is stored for preprocessing and analysis.

Preprocessing the PSD spectrograms involves reducing artifacts and normalizing data to enhance their quality. This step may include applying a bandpass filter to isolate relevant frequency ranges, resampling data to standardize time intervals, or removing sensor-specific biases. These preprocessing operations ensure that the PSD spectrogram data is optimized for subsequent neural network processing and improve its ability to localize regions of interest.

The Trainer 3220 accesses the preprocessed data from the RF Measurements Database 3218 to train or fine-tune models stored in the Models Database 3222. Training the neural network includes applying domain-specific augmentations, such as random erasing, AGC simulation, and noise floor adjustments, to improve feature extraction. These augmentations simulate real-world operational conditions, such as low-quality sensors or environmental interference, enabling the network to better identify and localize regions of interest. The effectiveness of these augmentations is measured by metrics such as Intersection over Union (IoU), reduced false positives, and reduced false negatives.

Once trained, the neural network applies self-supervised learning (SSL) to extract features from the PSD spectrograms and localize regions of interest within the spectral domain. Additionally, the network can associate hopping or intermittent signals within the PSD spectrograms to a specific source entity by analyzing signal characteristics such as frequency, time duration, and modulation patterns. These capabilities enable the network to detect and classify spectral objects while maintaining associations across multiple signal snapshots.

The Annotator module 3242 facilitates the refinement of neural network predictions through user-provided annotations. Annotated data is then processed by the Detections module 3244 to classify signals or objects within the PSD spectrograms. Bounding boxes for localized ROIs are generated to segment the detected spectral objects, and contour detection techniques are applied to distinguish overlapping signal regions. Contour detection ensures that portions of overlapping regions are assigned to the correct bounding boxes based on differences in signal intensity, frequency, or time duration. The Snapshot module 3246 stores segmented data for further analysis, enabling iterative refinement of the neural network.

The Data Access Layer (DAL) 3250 connects the Detections module 3244 to the Spectrum View 3252 and Detections Database 3252, presenting classification results and bounding box information to the user. The DAL also provides input to the Recommendation Engine 3260, which clusters signals and prioritizes representative signals for user annotation. The Recommendation Engine 3260 operates through a hierarchical structure that organizes annotation flows:
Flow 1—Initial Clustering (Proof of Concept): Signals are initially grouped into clusters based on shared characteristics such as frequency range, time duration, or modulation patterns. This clustering ensures broad coverage of signal types during early annotation stages.
Flow 2—Active Learning (Low Scores): Signals with low confidence scores from the neural network are prioritized for annotation, enabling the system to address uncertain classifications and improve the model's accuracy in challenging cases.
Flow 3—Unknowns: Signals that do not match any known categories are flagged as unknowns. These signals are prioritized for user annotation as potential new signal classes, supporting the discovery and classification of novel signal types.
Flow 4—Similar Annotations: Signals similar to previously annotated examples are grouped together to minimize redundancy. This flow leverages existing annotations to generalize classifications across signals with comparable features.

The annotated and clustered data is stored in the Recommendations Table 3270 and presented to users through the UI Backend/Frontend 3280. This interface allows users to prioritize annotations, refine model predictions, and enhance the diversity and quality of the dataset.

The neural network's outputs, including bounding boxes for localized ROIs, are validated using a holdout set of PSD spectrograms. Validation metrics such as mean average precision (mAP) and mean average recall (mAR) ensure the reliability of the trained model in detecting and classifying spectral objects. This iterative refinement process enhances the system's ability to adapt to new spectral environments and improve object detection tasks over time.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A method for processing a spectrum image measurement, the method comprising:
a. receiving a spectrum image measurement, wherein the spectrum image measurement comprises a plurality of power-frequency measured data values as a function of time and time data;
b. selecting a baseline prediction model based at least in part on the time data and an uncertainty model;
c. generating a residual error image by applying the baseline prediction result to the power-frequency data;
d. scanning the residual error image for an anomaly, wherein an anomaly is based at least in part on a portion of the residual error image exceeding a threshold range between a prediction result value and the power frequency measured data value; and
e. determining a portion of the anomalous power-frequency data set associated with a portion of the residual error image that exceeds the threshold range between the baseline prediction result value and the power frequency measured data value.

2. The method of claim 1, further comprising performing at least one local denoising step on the residual error image, wherein the performing at least one local denoising step on the residual error image further comprises:
a. creating a plurality of partitions of the anomalous power-frequency data set into a plurality of regions of low variance;
b. averaging the anomalous power-frequency measured data set within each of the plurality of partitions; and
c. generating a locally denoised residual error image with at least one local anomaly region and a local background image.

3. The method of claim 2, further comprising applying a classification model to the bounding box image of at least one anomaly region.

4. The method of claim 2, wherein performing at least one global denoising step on the locally denoised residual error image further comprises:
a. generating a globally denoised residual error image with at least one global anomaly region and a global background region;
b. determining a globally optimal segmentation solution on the locally denoised residual error image; and
c. generating a globally denoised residual error image based at least in part on the globally optimal segmentation solution on the locally denoised residual error image.

5. The method of claim 1, wherein selecting a prediction result based at least in part on the time data and an uncertainty model further comprises matching an attribute of the time data to the prediction result, wherein the time data is at least one of a seasonality characteristics, an event characteristic, and an external resources characteristic.

6. The method of claim 1, wherein selecting a prediction result based at least in part on the time data and an uncertainty model, wherein the selecting further comprises matching an attribute of the time data to the prediction result, wherein the time data is at least one of a seasonality characteristics, an event characteristic, or an external resources characteristic; and an attribute of a scanning network sensor is at least one of a sensor location, a sensor identification, a sensor health parameter, a sensor orientation, a sensor configuration parameter, a similarity graph, a historical clique graph, and/or a historical power spectrum data.

7. The method of claim 1, further comprising assessing the health of the scanning network sensor by comparing a consistency between the scanned clique and a subgraph of historical scanned cliques, wherein assessing the health of the scanning network sensor by comparing a consistency between the scanned clique and the subgraph of historical scanned cliques further comprises
a. extracting a scanned clique from the spectrum image measurement;
b. receiving the subgraph of historical scanned cliques of the network sensor;
c. applying a sensor data health monitoring service wherein the sensor data health monitoring service determines a consistency between the scanned clique and the subgraph of historical scanned cliques of the network sensor; and
d. associating a health status with the network sensor.

8. The method of claim 1, wherein generating a residual error image by applying the prediction result to the power-frequency data further comprises combining anomalous spectrogram regions.

9. The method of claim 1, wherein the spectrum image measurement comprises a
a. scanning the residual error image for an anomaly, wherein an anomaly is based at least in part on a portion of the residual error image exceeding a threshold range between a prediction result value and the power-frequency measured data value;
b. performing an update on the baseline prediction result to an updated prediction result when the residual error image is within the threshold range between the prediction result value and the power-frequency measured data value;
c. determining a portion of the anomalous power-frequency data set associated with a portion of the residual error image that exceeds the threshold range between the prediction result value and the power-frequency measured data value; and
d. generating a residual error image of the portion of the anomalous power-frequency data set associated with the portion of the residual error image that exceeds the threshold range between the prediction result value and the power-frequency measured data value.

10. A computer-implemented method for anomaly detection and classification of objects of interest, the computer-implemented method comprising instructions that, when executed by a processor, cause the processor to:
a. receive power spectral density (PSD) spectrogram data from one or more sensors, the spectrograms representing time-varying frequency power distributions within an RF spectrum;
b. use a neural network to create an objectness model using self-supervised learning (SSL) to identify invariant features within the PSD spectrogram data, wherein the objectness model localizes regions of interest within the PSD spectrogram data;
c. classify signals within the PSD spectrogram data according to the objectness model;
d. update the neural network by incorporating user-provided annotations into a training process of the neural network, wherein the neural network is refined using a semi-supervised learning paradigm to classify signals into predefined classes.

11. The method of claim 10, wherein updating the neural network further comprises using a hierarchical classification framework to classify detected signals, wherein known signals are mapped to predefined categories or families, and unknown signals are flagged as new signal types for further analysis.

12. The method of claim 11, wherein the hierarchical classification framework further provides multiple levels of granularity for signal classification, wherein the final classification is determined based on confidence scores at each node within a hierarchical tree structure.

13. The method of claim 10, further comprising prioritizing spectral images of interest for user review by using a recommendation engine to cluster RF signals and select representative signals for annotation, wherein the clustering maintains diversity and reduces user annotation effort.

14. The method of claim 13, further comprising: prompting the user to annotate the representative signals within the clustered spectral images; receiving the user annotations for the representative signals; and updating the objectness model by incorporating the annotated signals into a training process to refine the localization of regions of interest within the spectral images.

15. The method of claim 13, wherein the recommendation engine further clusters unknown signals and recommends representative signals for user annotation as new signal classes.

16. The method of claim 10, wherein recognizing signals within the spectral domain of the PSD spectrogram data further comprises associating hopping or intermittent signals across snapshots to the same source entity, enabling identification of individual emitters or sources within the RF spectrum.

17. The method of claim 16, wherein associating signals to the same source entity further comprises identifying the number of emitters and counting the number of sources within the vicinity of the sensor.

18. The method of claim 10, further comprising triggering follow-up actions based on detected anomalies, wherein policy-based responses include at least one of activating direction finding (DF), recording the signal, or alerting third-party systems.

19. The method of claim 10, wherein updating the neural network further comprises incorporating user feedback on detected anomalies, wherein the feedback is used to refine future detection and classification models through iterative training.

20. The method of claim 18, wherein the iterative training is automatically triggered by the system upon accumulation of sufficient user-provided annotations.

21. A method for processing power spectral density (PSD) spectrograms to detect spectral objects, the method comprising:
e. receiving PSD spectrograms from at least one sensor;
f. applying a neural network to localize regions of interest (ROIs) within the PSD spectrograms;
g. classifying one or more signals or objects within the PSD spectrograms; and
h. generating bounding boxes for localized ROIs.

22. The method of claim 20, wherein receiving PSD spectrograms from at least one sensor further comprises preprocessing the PSD spectrograms to reduce artifacts and normalize data within the PSD spectrograms, wherein the preprocessing includes at least one of applying a bandpass filter to isolate relevant frequency ranges, resampling to standardize time intervals, or removing sensor-specific biases.

23. The method of claim 20, further comprising training the neural network to localize regions of interest (ROIs) within the PSD spectrograms, wherein the training comprises applying domain-specific augmentations to modify PSD data within the PSD spectrograms, the domain-specific augmentations including at least one of random erasing, AGC simulation, and noise floor adjustments, wherein the augmented PSD spectrogram data improves localizing the regions of interest, the improvement being measured by Intersection over Union (IoU) or by reduced false positive and false negative rates.

24. The method of claim 20, wherein applying a neural network to localize regions of interest (ROIs) within the PSD spectrograms further comprises associating hopping or intermittent signals within the PSD spectrograms to a first source entity, wherein the association is based at least in part on matching signal characteristics across the PSD spectrograms, the signal characteristics including at least one of frequency, time duration, or modulation pattern.

25. The method of claim 20, wherein applying a neural network to localize regions of interest (ROIs) within the PSD spectrograms further comprises performing self-supervised learning (SSL) for feature extraction, wherein the SSL comprises applying domain-specific augmentations to simulate operational conditions, the augmentations including at least one of altering spectral resolution to simulate low-quality sensors, introducing artificial noise patterns to mimic environmental interference, or generating synthetic spectrograms from one or more known signal templates to expand a training dataset.

26. The method of claim 20, wherein applying a neural network to localize regions of interest (ROIs) within the PSD spectrograms further comprises applying objectness training by generating object annotations from multiple noisy labelers, wherein the annotations are refined using a consensus-based filtering approach to increase accuracy.

27. The method of claim 20, wherein applying a neural network to localize regions of interest (ROIs) within the PSD spectrograms further comprises fine-tuning the neural network, wherein the fine-tuning comprises prioritizing user-annotated PSD spectrograms based on diversity criteria, the diversity criteria including at least one of frequency distribution, signal intensity, or geographic origin of the spectrograms.

28. The method of claim 20, wherein generating bounding boxes for localized ROIs further comprises detecting contours of spectral objects to distinguish overlapping signal regions, wherein detecting contours at least assigns a portion of the overlapping signal regions to a first bounding box based on at least one of a difference in signal intensity, frequency, or time duration.

29. The method of claim 20, wherein generating bounding boxes for localized ROIs further comprises validating a trained model using a holdout set of PSD spectrograms, wherein the holdout set includes previously annotated signals and metrics for evaluation include mAP (mean average precisions) mAR (mean average recall) for the object detection tasks.
